(19) United States
(12) Patent Application Publication
(10) Pub. No.: US 2021/0014488 A1
(43) Pub. Date: Jan. 14, 2021

(54) IMAGE ENCODING/DECODING METHOD AND DEVICE, AND RECORDING MEDIUM STORING BITSTREAM

(71) Applicant: ELECTRONICS AND TELECOMMUNICATIONS RESEARCH INSTITUTE, Daejeon (KR)

(72) Inventors: Hyun Suk KO, Daejeon (KR); Sung Chang LIM, Daejeon (KR); Jung Won KANG, Daejeon (KR); Jin Ho LEE, Daejeon (KR); Ha Hyun LEE, Seoul (KR); Dong San JUN, Daejeon (KR); Hui Yong KIM, Daejeon (KR)

(73) Assignee: ELECTRONICS AND TELECOMMUNICATIONS RESEARCH INSTITUTE, Daejeon (KR)

(21) Appl. No.: 16/757,002

(22) PCT Filed: Oct. 19, 2018
(86) PCT No.: PCT/KR2018/012449

§ 371 Date: Apr. 17, 2020

(30) Foreign Application Priority Data
Oct. 20, 2017 (KR) 10-2017-0136461

(51) Int. Cl. H04N 19/117; H04N 19/176; H04N 19/159; H04N 19/14; H04N 19/105

(52) U.S. Cl. CPC H04N 19/117; H04N 19/176; H04N 19/105; H04N 19/14; H04N 19/159

(57) ABSTRACT

The present invention relates to an image encoding and decoding method. An image decoding method for the same includes: determining a reference sample of a current block; performing filtering for the reference sample on the basis of a feature of an area where the reference sample is included; and performing intra-prediction by using the reference sample for which filtering is performed.

### CROSS REFERENCE TO RELATED APPLICATIONS

This application is a U.S. National Stage Application of International Application No. PCT/KR2018/012449, filed on Oct. 19, 2018, which claims the benefit under 35 USC 119(a) and 365(b) of Korean Patent Application No. 10-2017-0136461, filed on Oct. 20, 2017 in the Korean Intellectual Property Office, the entire disclosure of which is incorporated herein by reference for all purposes.

### TECHNICAL FIELD

The present invention relates to an image encoding/decoding method and apparatus, and a recording medium storing a bitstream. More particularly, the present invention relates to an image encoding/decoding method and apparatus using various filtering methods.

### BACKGROUND ART

Recently, demands for high-resolution and high-quality images such as high definition (HD) images and ultra high definition (UHD) images, have increased in various application fields. However, higher resolution and quality image data has increasing amounts of data in comparison with conventional image data. Therefore, when transmitting image data by using a medium such as conventional wired and wireless broadband networks, or when storing image data by using a conventional storage medium, costs of transmitting and storing increase. In order to solve these problems occurring with an increase in resolution and quality of image data, high-efficiency image encoding/decoding techniques are required for higher-resolution and higher-quality images.

Image compression technology includes various techniques, including: an inter-prediction technique of predicting a pixel value included in a current picture from a previous or subsequent picture of the current picture; an intra-prediction technique of predicting a pixel value included in a current picture by using pixel information in the current picture; a transform and quantization technique for compressing energy of a residual signal; an entropy encoding technique of assigning a short code to a value with a high appearance frequency and assigning a long code to a value with a low appearance frequency; etc. Image data may be effectively compressed by using such image compression technology, and may be transmitted or stored.

A filtering method, which is used in a conventional image encoding/decoding method and apparatus, is limited in types and a method of applying the same, and thus encoding/decoding is limited.

### DISCLOSURE

### Technical Problem

The present invention provides various filtering methods performed in each step when performing image encoding/decoding so as to improve encoding/decoding efficiency of an image.

### Technical Solution

A method of decoding an image according to the present invention, the method may comprise determining a reference sample of a current block; performing filtering for the reference sample on the basis of a feature of an area where the reference sample is included; and performing intra-prediction by using the reference sample for which filtering is performed.

In the method of decoding an image, wherein the feature of the area where the reference sample is included is any one of a homogeneous area, an edge area, and a false edge area.

In the method of decoding an image, wherein in the performing of filtering for the reference sample, filtering is performed by using a smoothing filter when the feature of the area where the reference sample is included is the homogeneous area.

In the method of decoding an image, wherein in the performing of filtering for the reference sample, filtering is performed by using an edge-preserving filter when the feature of the area where the reference sample is included is the edge area.

In the method of decoding an image, wherein in the performing of filtering for the reference sample, filtering is performed by excluding a sample determined to be noise when the feature of the area where the reference sample is included is the false edge area.

In the method of decoding an image, wherein the feature of the area where the reference sample is included is determined on the basis of a degree of homogeneity of the area.

In the method of decoding an image, further comprising: determining whether or not to perform filtering for the reference sample on the basis of at least one of a size of the current block, a form of the current block, an intra-prediction mode of the current block, a division depth of the current block, and a pixel component of the current block, wherein the performing of filtering for the reference sample is performed on the basis of the determined result.

In the method of decoding an image, wherein the performing of filtering for the reference sample includes: determining a filter length on the basis of at least one of a size of the current block, a form of the current block, an intra-prediction mode of the current block, a division depth of the current block, and a pixel component of the current block; and performing filtering for the reference sample on the basis of the determined filter length.

In the method of decoding an image, wherein the reference sample of the current block is at least one of at least one reconstructed sample line positioned at a left side of the current block and at least one reconstructed sample line positioned at an upper side of the current block.

A method of encoding an image according to the present invention, the method may comprise determining a reference sample of a current block; performing filtering for the reference sample on the basis of a feature of an area where the reference sample is included; and performing intra-prediction by using the reference sample for which filtering is performed.

In the method of encoding an image, wherein the feature of the area where the reference sample is included is any one of a homogeneous area, an edge area, and a false edge area.

In the method of encoding an image, wherein in the performing of filtering for the reference sample, filtering is performed by using a smoothing filter when the feature of the area where the reference sample is included is the homogeneous area.

In the method of encoding an image, wherein in the performing of filtering for the reference sample, filtering is performed by using an edge-preserving filter when the feature of the area where the reference sample is included is the edge area.

In the method of encoding an image, wherein in the performing of filtering for the reference sample, filtering is performed by excluding a pixel determined to be noise when the feature of the area where the reference sample is included is the false edge area.

In the method of encoding an image, wherein the feature of the area where the reference sample is included is determined on the basis of a degree of homogeneity of the area.

In the method of encoding an image, further comprising: determining whether or not to perform filtering for the reference sample on the basis of at least one of a size of the current block, a form of the current block, an intra-prediction mode of the current block, a division depth of the current block, and a pixel component of the current block, wherein the filtering for the reference sample is performed on the basis of the determined result.

In the method of encoding an image, wherein the performing of filtering for the reference sample includes: determining a filter length on the basis of at least one of a size of the current block, a form of the current block, an intra-prediction mode of the current block, a division depth of the current block, and a pixel component of the current block; and performing filtering for the reference sample on the basis of the determined filter length.

In the method of encoding an image, wherein the reference sample of the current block is at least one of at least one reconstructed sample line positioned at a left side of the current block, and at least one reconstructed sample line positioned at an upper side of the current block.

A recording medium according to the present invention, the recoding medium storing a bitstream generated through execution of an image encoding method including: determining a reference sample of a current block; performing filtering for the reference sample on the basis of a feature of an area where the reference sample is included; and performing intra-prediction by using the reference sample for which filtering is performed.

### Advantageous Effects

The present invention can provide various filtering methods performed in each step when performing image encoding/decoding so as to improve encoding/decoding efficiency of an image.

The present invention can improve prediction efficiency by generating a prediction image by using a reference sample close to an original image.

The present invention can improve ringing artifacts in an object boundary area of an image and contour artifacts occurring when performing directional prediction.

According to the present invention, encoding and decoding efficiency of an image can be improved.

According to the present invention, a calculation degree of complexity of image encoder and decoder can be reduced.

### DESCRIPTION OF DRAWINGS

FIG. 1 is a block diagram showing configurations of an encoding apparatus according to an embodiment of the present invention.

FIG. 2 is a block diagram showing configurations of a decoding apparatus according to an embodiment of the present invention.

FIG. 3 is a view schematically showing a partition structure of an image when encoding and decoding the image.

FIG. 4 is a view showing an intra-prediction process.

FIG. 5 is a view showing an inter-prediction process

FIG. 6 is a view showing a transform and quantization process

FIG. 7 is a view showing an embodiment example of configuring a reference sample by using a plurality of reconstructed sample lines.

FIG. 8 is a view showing an image feature of an area where a reference sample is included according to an embodiment of the present invention.

FIG. 9 is a view showing a method of deriving a degree of homogeneity of an image according to an embodiment of the present invention.

FIG. 10 is a view showing a method of deriving a degree of homogeneity of an image by using a gradient according to an embodiment of the present invention.

FIG. 11 is a view showing a direction to which filtering is applied according to an embodiment of the present invention.

FIG. 12 is a view showing a pixel area used for filtering according to an embodiment of the present invention.

FIG. 13 is a view showing an embodiment example of applying filtering in a ¼ (or quarter-pel) unit.

FIG. 14 is a view showing an embodiment example of performing filtering when an area used for filtering is positioned outside the boundary at a partial thereof.

FIG. 15 is a view showing a 1D filter according to an embodiment of the present invention.

FIG. 16 is a view showing a 2D filter according to an embodiment of the present invention.

FIG. 17 is a view of a flowchart showing an image decoding method according to an embodiment of the present invention.

FIG. 18 is a view of a flowchart showing an image decoding method according to another embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening there between. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

Hereinafter, an image may mean a picture configuring a video, or may mean the video itself. For example, “encoding or decoding or both of an image” may mean “encoding or decoding or both of a moving picture”, and may mean “encoding or decoding or both of one image among images of a moving picture.”

Hereinafter, terms “moving picture” and “video” may be used as the same meaning and be replaced with each other.

Hereinafter, a target image may be an encoding target image which is a target of encoding and/or a decoding target image which is a target of decoding. Also, a target image may be an input image inputted to an encoding apparatus, and an input image inputted to a decoding apparatus. Here, a target image may have the same meaning with the current image.

Hereinafter, terms “image”, “picture, “frame” and “screen” may be used as the same meaning and be replaced with each other.

Hereinafter, a target block may be an encoding target block which is a target of encoding and/or a decoding target block which is a target of decoding. Also, a target block may be the current block which is a target of current encoding and/or decoding. For example, terms “target block” and “current block” may be used as the same meaning and be replaced with each other.

Hereinafter, terms “block” and “unit” may be used as the same meaning and be replaced with each other. Or a “block” may represent a specific unit.

Hereinafter, terms “region” and “segment” may be replaced with each other.

Hereinafter, a specific signal may be a signal representing a specific block. For example, an original signal may be a signal representing a target block. A prediction signal may be a signal representing a prediction block. A residual signal may be a signal representing a residual block.

In embodiments, each of specific information, data, flag, index, element and attribute, etc. may have a value. A value of information, data, flag, index, element and attribute equal to “0” may represent a logical false or the first predefined value. In other words, a value “0”, a false, a logical false and the first predefined value may be replaced with each other. A value of information, data, flag, index, element and attribute equal to “1” may represent a logical true or the second predefined value. In other words, a value “1”, a true, a logical true and the second predefined value may be replaced with each other.

When a variable i or j is used for representing a column, a row or an index, a value of i may be an integer equal to or greater than 0, or equal to or greater than 1. That is, the column, the row, the index, etc. may be counted from 0 or may be counted from 1.

### Description of Terms

Encoder: means an apparatus performing encoding. That is, means an encoding apparatus.

Decoder: means an apparatus performing decoding. That is, means a decoding apparatus.

Block: is an M×N array of a sample. Herein, M and N may mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit constituting a block. It may be expressed as a value from 0 to 2Bd−1 according to a bit depth (Bd). In the present invention, the sample may be used as a meaning of a pixel. That is, a sample, a pel, a pixel may have the same meaning with each other.

Unit: may refer to an encoding and decoding unit. When encoding and decoding an image, the unit may be a region generated by partitioning a single image. In addition, the unit may mean a subdivided unit when a single image is partitioned into subdivided units during encoding or decoding. That is, an image may be partitioned into a plurality of units. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a square shape, a rectangular shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method, a binary-tree partitioning method and ternary-tree partitioning method to configure a lower unit such as coding unit, prediction unit, transform unit, etc. It may be used as a term for designating a sample block that becomes a process unit when encoding/decoding an image as an input image. Here, the quad-tree may mean a quaternary-tree.

Coding Tree Block: may be used as a term for designating any one of a Y coding tree block, Cb coding tree block, and Cr coding tree block.

Neighbor Block: may mean a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: may mean a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at a corresponding position as the current block of the current picture within a reference image, or a neighbor block thereof.

Unit Depth: may mean a partitioned degree of a unit. In a tree structure, the highest node (Root Node) may correspond to the first unit which is not partitioned. Also, the highest node may have the least depth value. In this case, the highest node may have a depth of level 0. A node having a depth of level 1 may represent a unit generated by partitioning once the first unit. A node having a depth of level 2 may represent a unit generated by partitioning twice the first unit. A node having a depth of level n may represent a unit generated by partitioning n-times the first unit. A Leaf Node may be the lowest node and a node which cannot be partitioned further. A depth of a Leaf Node may be the maximum level. For example, a predefined value of the maximum level may be 3. A depth of a root node may be the lowest and a depth of a leaf node may be the deepest. In addition, when a unit is expressed as a tree structure, a level in which a unit is present may mean a unit depth.

Bitstream: may mean a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, and tile header information.

Parsing: may mean determination of a value of a syntax element by performing entropy decoding, or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Mode: may be information indicating a mode encoded/decoded with intra prediction or a mode encoded/decoded with inter prediction.

Prediction Unit: may mean a basic unit when performing prediction such as inter-prediction, intra-prediction, inter-compensation, intra-compensation, and motion compensation. A single prediction unit may be partitioned into a plurality of partitions having a smaller size, or may be partitioned into a plurality of lower prediction units. A plurality of partitions may be a basic unit in performing prediction or compensation. A partition which is generated by dividing a prediction unit may also be a prediction unit.

Prediction Unit Partition: may mean a form obtained by partitioning a prediction unit.

Reference Picture List: may refer to a list including one or more reference pictures used for inter prediction or motion compensation. There are several types of usable reference picture lists, including LC (List combined), L0 (List 0), L1 (List 1), L2 (List 2), L3 (List 3).

Inter prediction indicator: may refer to a direction of inter prediction (unidirectional prediction, bidirectional prediction, etc.) of a current block. Alternatively, it may refer to the number of reference pictures used to generate a prediction block of a current block. Alternatively, it may refer to the number of prediction blocks used at the time of performing inter prediction or motion compensation on a current block.

Prediction list utilization flag: indicates whether a prediction block is generated using at least one reference picture in a specific reference picture list. An inter prediction indicator can be derived using a prediction list utilization flag, and conversely, a prediction list utilization flag can be derived using an inter prediction indicator. For example, when the prediction list utilization flag has a first value of zero (0), it means that a reference picture in a reference picture list is not used to generate a prediction block. On the other hand, when the prediction list utilization flag has a second value of one (1), it means that a reference picture list is used to generate a prediction block.

Reference picture index: may refer to an index indicating a specific reference picture in a reference picture list.

Reference picture: may mean a reference picture which is referred to by a specific block for the purposes of inter prediction or motion compensation of the specific block. Alternatively, the reference picture may be a picture including a reference block referred to by a current block for inter prediction or motion compensation. Hereinafter, the terms “reference picture” and “reference image” have the same meaning and can be interchangeably.

Motion vector: may be a two-dimensional vector used for inter prediction or motion compensation. The motion vector may mean an offset between an encoding/decoding target block and a reference block. For example, (mvX, mvY) may represent a motion vector. Here, mvX may represent a horizontal component and mvY may represent a vertical component.

Search range: may be a two-dimensional region which is searched to retrieve a motion vector during inter prediction. For example, the size of the search range may be M×N. Here, M and N are both integers.

Motion vector candidate: may refer to a prediction candidate block or a motion vector of the prediction candidate block when predicting a motion vector. In addition, a motion vector candidate may be included in a motion vector candidate list.

Motion vector candidate list: may mean a list composed of one or more motion vector candidates.

Motion vector candidate index: may mean an indicator indicating a motion vector candidate in a motion vector candidate list. Alternatively, it may be an index of a motion vector predictor.

Motion information: may mean information including at least one of the items including a motion vector, a reference picture index, an inter prediction indicator, a prediction list utilization flag, reference picture list information, a reference picture, a motion vector candidate, a motion vector candidate index, a merge candidate, and a merge index.

Merge candidate list: may mean a list composed of one or more merge candidates.

Merge candidate: may mean a spatial merge candidate, a temporal merge candidate, a combined merge candidate, a combined bi-predictive merge candidate, or a zero merge candidate. The merge candidate may include motion information such as an inter prediction indicator, a reference picture index for each list, a motion vector, a prediction list utilization flag, and an inter prediction indicator.

Merge index: may mean an indicator indicating a merge candidate in a merge candidate list. Alternatively, the merge index may indicate a block from which a merge candidate has been derived, among reconstructed blocks spatially/temporally adjacent to a current block. Alternatively, the merge index may indicate at least one piece of motion information of a merge candidate.

Transform Unit: may mean a basic unit when performing encoding/decoding such as transform, inverse-transform, quantization, dequantization, transform coefficient encoding/decoding of a residual signal. A single transform unit may be partitioned into a plurality of lower-level transform units having a smaller size. Here, transformation/inverse-transformation may comprise at least one among the first transformation/the first inverse-transformation and the second transformation/the second inverse-transformation.

Scaling: may mean a process of multiplying a quantized level by a factor. A transform coefficient may be generated by scaling a quantized level. The scaling also may be referred to as dequantization.

Quantization Parameter: may mean a value used when generating a quantized level using a transform coefficient during quantization. The quantization parameter also may mean a value used when generating a transform coefficient by scaling a quantized level during dequantization. The quantization parameter may be a value mapped on a quantization step size.

Delta Quantization Parameter: may mean a difference value between a predicted quantization parameter and a quantization parameter of an encoding/decoding target unit.

Scan: may mean a method of sequencing coefficients within a unit, a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform Coefficient: may mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: may mean a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: may mean a transform coefficient having a value other than zero, or a transform coefficient level or a quantized level having a value other than zero.

Quantization Matrix: may mean a matrix used in a quantization process or a dequantization process performed to improve subjective or objective image quality. The quantization matrix also may be referred to as a scaling list.

Quantization Matrix Coefficient: may mean each element within a quantization matrix. The quantization matrix coefficient also may be referred to as a matrix coefficient.

Default Matrix: may mean a predetermined quantization matrix preliminarily defined in an encoder or a decoder.

Non-default Matrix: may mean a quantization matrix that is not preliminarily defined in an encoder or a decoder but is signaled by a user.

Statistic Value: a statistic value for at least one among a variable, an encoding parameter, a constant value, etc. which have a computable specific value may be one or more among an average value, a weighted average value, a weighted sum value, the minimum value, the maximum value, the most frequent value, a median value, an interpolated value of the corresponding specific values.

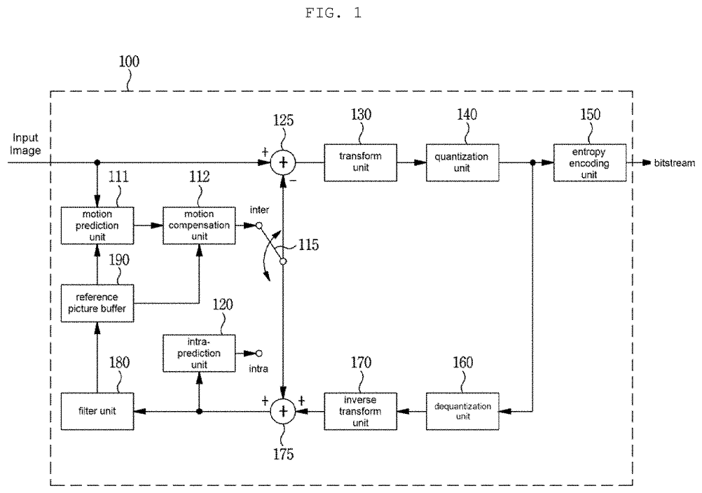

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, a inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream including encoded information through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual block using a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a sample of a block that has been already encoded/decoded and is adjacent to a current block as a reference sample. The intra-prediction unit 120 may perform spatial prediction for the current block by using a reference sample, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 112 may generate a prediction block by performing motion compensation for the current block using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a residual of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of sample information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level (quantized level), the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block shape, unit/block partition structure, whether to partition of a quad-tree form, whether to partition of a binary-tree form, a partition direction of a binary-tree form (horizontal direction or vertical direction), a partition form of a binary-tree form (symmetric partition or asymmetric partition), whether or not a current coding unit is partitioned by ternary tree partitioning, direction (horizontal or vertical direction) of the ternary tree partitioning, type (symmetric or asymmetric type) of the ternary tree partitioning, whether a current coding unit is partitioned by multi-type tree partitioning, direction (horizontal or vertical direction) of the multi-type three partitioning, type (symmetric or asymmetric type) of the multi-type tree partitioning, and a tree (binary tree or ternary tree) structure of the multi-type tree partitioning, a prediction mode (intra prediction or inter prediction), a luma intra-prediction mode/direction, a chroma intra-prediction mode/direction, intra partition information, inter partition information, a coding block partition flag, a prediction block partition flag, a transform block partition flag, a reference sample filtering method, a reference sample filter tab, a reference sample filter coefficient, a prediction block filtering method, a prediction block filter tap, a prediction block filter coefficient, a prediction block boundary filtering method, a prediction block boundary filter tab, a prediction block boundary filter coefficient, an intra-prediction mode, an inter-prediction mode, motion information, a motion vector, a motion vector difference, a reference picture index, a inter-prediction angle, an inter-prediction indicator, a prediction list utilization flag, a reference picture list, a reference picture, a motion vector predictor index, a motion vector predictor candidate, a motion vector candidate list, whether to use a merge mode, a merge index, a merge candidate, a merge candidate list, whether to use a skip mode, an interpolation filter type, an interpolation filter tab, an interpolation filter coefficient, a motion vector size, a presentation accuracy of a motion vector, a transform type, a transform size, information of whether or not a primary (first) transform is used, information of whether or not a secondary transform is used, a primary transform index, a secondary transform index, information of whether or not a residual signal is present, a coded block pattern, a coded block flag (CBF), a quantization parameter, a quantization parameter residue, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample offset category, an adaptive sample offset type, whether to apply an adaptive loop filter, an adaptive loop filter coefficient, an adaptive loop filter tab, an adaptive loop filter shape/form, a binarization/inverse-binarization method, a context model determining method, a context model updating method, whether to perform a regular mode, whether to perform a bypass mode, a context bin, a bypass bin, a significant coefficient flag, a last significant coefficient flag, a coded flag for a unit of a coefficient group, a position of the last significant coefficient, a flag for whether a value of a coefficient is larger than 1, a flag for whether a value of a coefficient is larger than 2, a flag for whether a value of a coefficient is larger than 3, information on a remaining coefficient value, a sign information, a reconstructed luma sample, a reconstructed chroma sample, a residual luma sample, a residual chroma sample, a luma transform coefficient, a chroma transform coefficient, a quantized luma level, a quantized chroma level, a transform coefficient level scanning method, a size of a motion vector search area at a decoder side, a shape of a motion vector search area at a decoder side, a number of time of a motion vector search at a decoder side, information on a CTU size, information on a minimum block size, information on a maximum block size, information on a maximum block depth, information on a minimum block depth, an image displaying/outputting sequence, slice identification information, a slice type, slice partition information, tile identification information, a tile type, tile partition information, a picture type, a bit depth of an input sample, a bit depth of a reconstruction sample, a bit depth of a residual sample, a bit depth of a transform coefficient, a bit depth of a quantized level, and information on a luma signal or information on a chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image in reference picture buffer 190.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAO), and an adaptive loop filter (ALF) to a reconstructed sample, a reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based samples included in several rows or columns which are included in the block. When a deblocking filter is applied to a block, another filter may be applied according to a required deblocking filtering strength.

In order to compensate an encoding error, a proper offset value may be added to a sample value by using a sample adaptive offset. The sample adaptive offset may correct an offset of a deblocked image from an original image by a sample unit. A method of partitioning samples of an image into a predetermined number of regions, determining a region to which an offset is applied, and applying the offset to the determined region, or a method of applying an offset in consideration of edge information on each sample may be used.

The adaptive loop filter may perform filtering based on a comparison result of the filtered reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190. A reconstructed block processed by the filter unit 180 may be a part of a reference image. That is, a reference image is a reconstructed image composed of reconstructed blocks processed by the filter unit 180. The stored reference image may be used later in inter prediction or motion compensation.

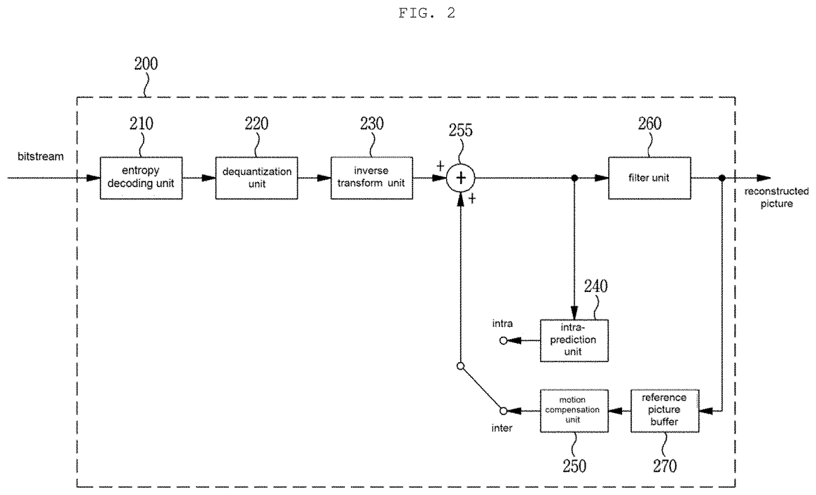

FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, a inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be a inverse-process of the entropy encoding method described above.

In order to decode a transform coefficient level (quantized level), the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing, for the current block, spatial prediction that uses a sample value of a block adjacent to a decoding target block and which has been already decoded.

When an inter mode is used, the motion compensation unit 250 may generate a prediction block by performing, for the current block, motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction. A reconstructed block processed by the filter unit 260 may be a part of a reference image. That is, a reference image is a reconstructed image composed of reconstructed blocks processed by the filter unit 260. The stored reference image may be used later in inter prediction or motion compensation.

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra prediction mode and an inter prediction mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit may be partitioned into a plurality of lower level units hierarchically associated with depth information based on a tree structure. In other words, a unit and a lower level unit generated by partitioning the unit may correspond to a node and a child node of the node, respectively. Each of partitioned lower unit may have depth information. Depth information may be information representing a size of a CU, and may be stored in each CU. Unit depth represents times and/or degrees related to partitioning a unit. Therefore, partitioning information of a lower-level unit may comprise information on a size of the lower-level unit.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. By the recursive partitioning, at least one among a height and a width of a CU after partitioning may decrease comparing with at least one among a height and a width of a CU before partitioning. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning. For example, for each depth, a CU which is not partitioned may have a size of 2N×2N. Also, in case of a CU which is partitioned, a CU with a size of 2N×2N may be partitioned into four CUs with a size of N×N. A size of N may decrease to half as a depth increase by 1.

In addition, information whether or not the CU is partitioned may be represented by using partition information of the CU. The partition information may be 1-bit information. All CUs, except for a SCU, may include partition information. For example, when a value of partition information is 1, the CU may not be partitioned, when a value of partition information is 2, the CU may be partitioned.

Referring to FIG. 3, an LCU having a depth 0 may be a 64×64 block. 0 may be a minimum depth. A SCU having a depth 3 may be an 8×8 block. 3 may be a maximum depth. A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit may be partitioned into a quad-tree form.

For example, when one coding unit is partitioned into two sub-coding units, the horizontal or vertical size (width or height) of each of the two sub-coding units may be half the horizontal or vertical size of the original coding unit. For example, when a coding unit having a size of 32×32 is vertically partitioned into two sub-coding units, each of the two sub-coding units may have a size of 16×32. For example, when a coding unit having a size of 8×32 is horizontally partitioned into two sub-coding units, each of the two sub-coding units may have a size of 8×16. When one coding unit is partitioned into two sub-coding units, it can be said that the coding unit is binary-partitioned or is partitioned by a binary tree partition structure.

For example, when one coding unit is partitioned into three sub-coding units, the horizontal or vertical size of the coding unit can be partitioned with a ratio of 1:2:1, thereby producing three sub-coding units whose horizontal or vertical sizes are in a ratio of 1:2:1. For example, when a coding unit having a size of 16×32 is horizontally partitioned into three sub-coding units, the three sub-coding units may have sizes of 16×8, 16×16, and 16×8 respectively, in the order from the uppermost to the lowermost sub-coding unit. For example, when a coding unit having a size of 32×32 is vertically split into three sub-coding units, the three sub-coding units may have sizes of 8×32, 16×32, and 8×32, respectively in the order from the left to the right sub-coding unit. When one coding unit is partitioned into three sub-coding units, it can be said that the coding unit is ternary-partitioned or partitioned by a ternary tree partition structure.

In FIG. 3, a coding tree unit (CTU) 320 is an example of a CTU to which a quad tree partition structure, a binary tree partition structure, and a ternary tree partition structure are all applied.

As described above, in order to partition the CTU, at least one of a quad tree partition structure, a binary tree partition structure, and a ternary tree partition structure may be applied. Various tree partition structures may be sequentially applied to the CTU, according to a predetermined priority order. For example, the quad tree partition structure may be preferentially applied to the CTU. A coding unit that cannot be partitioned any longer using a quad tree partition structure may correspond to a leaf node of a quad tree. A coding unit corresponding to a leaf node of a quad tree may serve as a root node of a binary and/or ternary tree partition structure. That is, a coding unit corresponding to a leaf node of a quad tree may be further partitioned by a binary tree partition structure or a ternary tree partition structure, or may not be further partitioned. Therefore, by preventing a coding block that results from binary tree partitioning or ternary tree partitioning of a coding unit corresponding to a leaf node of a quad tree from undergoing further quad tree partitioning, block partitioning and/or signaling of partition information can be effectively performed.

The fact that a coding unit corresponding to a node of a quad tree is partitioned may be signaled using quad partition information. The quad partition information having a first value (e.g., “1”) may indicate that a current coding unit is partitioned by the quad tree partition structure. The quad partition information having a second value (e.g., “0”) may indicate that a current coding unit is not partitioned by the quad tree partition structure. The quad partition information may be a flag having a predetermined length (e.g., one bit).

There may not be a priority between the binary tree partitioning and the ternary tree partitioning. That is, a coding unit corresponding to a leaf node of a quad tree may further undergo arbitrary partitioning among the binary tree partitioning and the ternary tree partitioning. In addition, a coding unit generated through the binary tree partitioning or the ternary tree partitioning may undergo a further binary tree partitioning or a further ternary tree partitioning, or may not be further partitioned.

A tree structure in which there is no priority among the binary tree partitioning and the ternary tree partitioning is referred to as a multi-type tree structure. A coding unit corresponding to a leaf node of a quad tree may serve as a root node of a multi-type tree. Whether to partition a coding unit which corresponds to a node of a multi-type tree may be signaled using at least one of multi-type tree partition indication information, partition direction information, and partition tree information. For partitioning of a coding unit corresponding to a node of a multi-type tree, the multi-type tree partition indication information, the partition direction, and the partition tree information may be sequentially signaled.

The multi-type tree partition indication information having a first value (e.g., “1”) may indicate that a current coding unit is to undergo a multi-type tree partitioning. The multi-type tree partition indication information having a second value (e.g., “0”) may indicate that a current coding unit is not to undergo a multi-type tree partitioning.

When a coding unit corresponding to a node of a multi-type tree is further partitioned by a multi-type tree partition structure, the coding unit may include partition direction information. The partition direction information may indicate in which direction a current coding unit is to be partitioned for the multi-type tree partitioning. The partition direction information having a first value (e.g., “1”) may indicate that a current coding unit is to be vertically partitioned. The partition direction information having a second value (e.g., “0”) may indicate that a current coding unit is to be horizontally partitioned.

When a coding unit corresponding to a node of a multi-type tree is further partitioned by a multi-type tree partition structure, the current coding unit may include partition tree information. The partition tree information may indicate a tree partition structure which is to be used for partitioning of a node of a multi-type tree. The partition tree information having a first value (e.g., “1”) may indicate that a current coding unit is to be partitioned by a binary tree partition structure. The partition tree information having a second value (e.g., “0”) may indicate that a current coding unit is to be partitioned by a ternary tree partition structure.

The partition indication information, the partition tree information, and the partition direction information may each be a flag having a predetermined length (e.g., one bit).

At least any one of the quadtree partition indication information, the multi-type tree partition indication information, the partition direction information, and the partition tree information may be entropy encoded/decoded. For the entropy-encoding/decoding of those types of information, information on a neighboring coding unit adjacent to the current coding unit may be used. For example, there is a high probability that the partition type (the partitioned or non-partitioned, the partition tree, and/or the partition direction) of a left neighboring coding unit and/or an upper neighboring coding unit of a current coding unit is similar to that of the current coding unit. Therefore, context information for entropy encoding/decoding of the information on the current coding unit may be derived from the information on the neighboring coding units. The information on the neighboring coding units may include at least any one of quad partition information, multi-type tree partition indication information, partition direction information, and partition tree information.

As another example, among binary tree partitioning and ternary tree partitioning, binary tree partitioning may be preferentially performed. That is, a current coding unit may primarily undergo binary tree partitioning, and then a coding unit corresponding to a leaf node of a binary tree may be set as a root node for ternary tree partitioning. In this case, neither quad tree partitioning nor binary tree partitioning may not be performed on the coding unit corresponding to a node of a ternary tree.

A coding unit that cannot be partitioned by a quad tree partition structure, a binary tree partition structure, and/or a ternary tree partition structure becomes a basic unit for coding, prediction and/or transformation. That is, the coding unit cannot be further partitioned for prediction and/or transformation. Therefore, the partition structure information and the partition information used for partitioning a coding unit into prediction units and/or transformation units may not be present in a bit stream.

However, when the size of a coding unit (i.e., a basic unit for partitioning) is larger than the size of a maximum transformation block, the coding unit may be recursively partitioned until the size of the coding unit is reduced to be equal to or smaller than the size of the maximum transformation block. For example, when the size of a coding unit is 64×64 and when the size of a maximum transformation block is 32×32, the coding unit may be partitioned into four 32×32 blocks for transformation. For example, when the size of a coding unit is 32×64 and the size of a maximum transformation block is 32×32, the coding unit may be partitioned into two 32×32 blocks for the transformation. In this case, the partitioning of the coding unit for transformation is not signaled separately, and may be determined through comparison between the horizontal or vertical size of the coding unit and the horizontal or vertical size of the maximum transformation block. For example, when the horizontal size (width) of the coding unit is larger than the horizontal size (width) of the maximum transformation block, the coding unit may be vertically bisected. For example, when the vertical size (length) of the coding unit is larger than the vertical size (length) of the maximum transformation block, the coding unit may be horizontally bisected.

Information of the maximum and/or minimum size of the coding unit and information of the maximum and/or minimum size of the transformation block may be signaled or determined at an upper level of the coding unit. The upper level may be, for example, a sequence level, a picture level, a slice level, or the like. For example, the minimum size of the coding unit may be determined to be 4×4. For example, the maximum size of the transformation block may be determined to be 64×64. For example, the minimum size of the transformation block may be determined to be 4×4.

Information of the minimum size (quad tree minimum size) of a coding unit corresponding to a leaf node of a quad tree and/or information of the maximum depth (the maximum tree depth of a multi-type tree) from a root node to a leaf node of the multi-type tree may be signaled or determined at an upper level of the coding unit. For example, the upper level may be a sequence level, a picture level, a slice level, or the like. Information of the minimum size of a quad tree and/or information of the maximum depth of a multi-type tree may be signaled or determined for each of an intra-picture slice and an inter-picture slice.

Difference information between the size of a CTU and the maximum size of a transformation block may be signaled or determined at an upper level of the coding unit. For example, the upper level may be a sequence level, a picture level, a slice level, or the like. Information of the maximum size of the coding units corresponding to the respective nodes of a binary tree (hereinafter, referred to as a maximum size of a binary tree) may be determined based on the size of the coding tree unit and the difference information. The maximum size of the coding units corresponding to the respective nodes of a ternary tree (hereinafter, referred to as a maximum size of a ternary tree) may vary depending on the type of slice. For example, for an intra-picture slice, the maximum size of a ternary tree may be 32×32. For example, for an inter-picture slice, the maximum size of a ternary tree may be 128×128. For example, the minimum size of the coding units corresponding to the respective nodes of a binary tree (hereinafter, referred to as a minimum size of a binary tree) and/or the minimum size of the coding units corresponding to the respective nodes of a ternary tree (hereinafter, referred to as a minimum size of a ternary tree) may be set as the minimum size of a coding block.

As another example, the maximum size of a binary tree and/or the maximum size of a ternary tree may be signaled or determined at the slice level. Alternatively, the minimum size of the binary tree and/or the minimum size of the ternary tree may be signaled or determined at the slice level.

Depending on size and depth information of the above-described various blocks, quad partition information, multi-type tree partition indication information, partition tree information and/or partition direction information may be included or may not be included in a bit stream.

For example, when the size of the coding unit is not larger than the minimum size of a quad tree, the coding unit does not contain quad partition information. Thus, the quad partition information may be deduced from a second value.

For example, when the sizes (horizontal and vertical sizes) of a coding unit corresponding to a node of a multi-type tree are larger than the maximum sizes (horizontal and vertical sizes) of a binary tree and/or the maximum sizes (horizontal and vertical sizes) of a ternary tree, the coding unit may not be binary-partitioned or ternary-partitioned. Accordingly, the multi-type tree partition indication information may not be signaled but may be deduced from a second value.

Alternatively, when the sizes (horizontal and vertical sizes) of a coding unit corresponding to a node of a multi-type tree are the same as the maximum sizes (horizontal and vertical sizes) of a binary tree and/or are two times as large as the maximum sizes (horizontal and vertical sizes) of a ternary tree, the coding unit may not be further binary-partitioned or ternary-partitioned. Accordingly, the multi-type tree partition indication information may not be signaled but be derived from a second value. This is because when a coding unit is partitioned by a binary tree partition structure and/or a ternary tree partition structure, a coding unit smaller than the minimum size of a binary tree and/or the minimum size of a ternary tree is generated.

Alternatively, when the depth of a coding unit corresponding to a node of a multi-type tree is equal to the maximum depth of the multi-type tree, the coding unit may not be further binary-partitioned and/or ternary-partitioned. Accordingly, the multi-type tree partition indication information may not be signaled but may be deduced from a second value.

Alternatively, only when at least one of vertical direction binary tree partitioning, horizontal direction binary tree partitioning, vertical direction ternary tree partitioning, and horizontal direction ternary tree partitioning is possible for a coding unit corresponding to a node of a multi-type tree, the multi-type tree partition indication information may be signaled. Otherwise, the coding unit may not be binary-partitioned and/or ternary-partitioned. Accordingly, the multi-type tree partition indication information may not be signaled but may be deduced from a second value.

Alternatively, only when both of the vertical direction binary tree partitioning and the horizontal direction binary tree partitioning or both of the vertical direction ternary tree partitioning and the horizontal direction ternary tree partitioning are possible for a coding unit corresponding to a node of a multi-type tree, the partition direction information may be signaled. Otherwise, the partition direction information may not be signaled but may be derived from a value indicating possible partitioning directions.

Alternatively, only when both of the vertical direction binary tree partitioning and the vertical direction ternary tree partitioning or both of the horizontal direction binary tree partitioning and the horizontal direction ternary tree partitioning are possible for a coding tree corresponding to a node of a multi-type tree, the partition tree information may be signaled. Otherwise, the partition tree information may not be signaled but be deduced from a value indicating a possible partitioning tree structure.

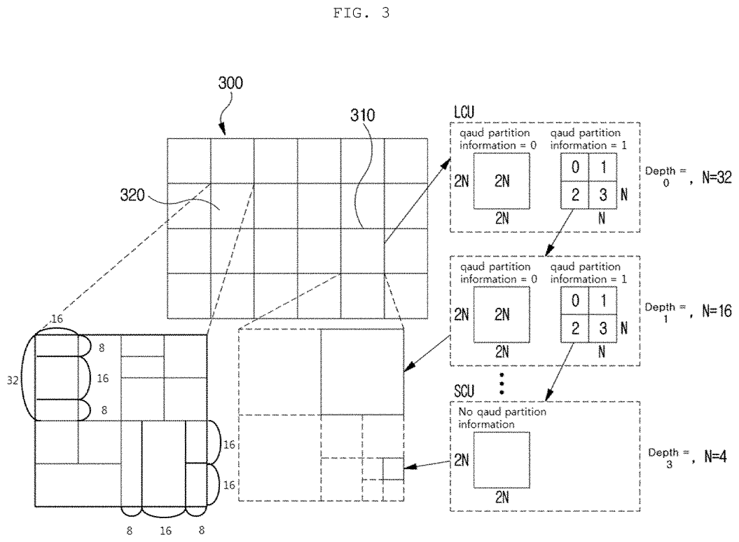

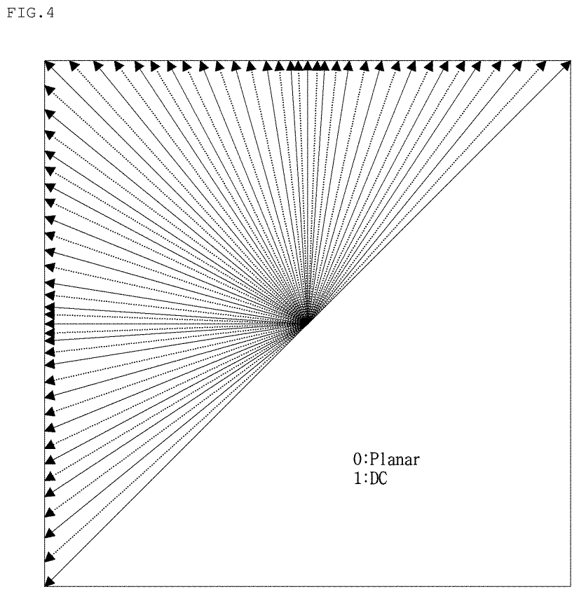

FIG. 4 is a view showing an intra-prediction process.

Arrows from center to outside in FIG. 4 may represent prediction directions of intra prediction modes.

Intra encoding and/or decoding may be performed by using a reference sample of a neighbor block of the current block. A neighbor block may be a reconstructed neighbor block. For example, intra encoding and/or decoding may be performed by using an encoding parameter or a value of a reference sample included in a reconstructed neighbor block.

A prediction block may mean a block generated by performing intra prediction. A prediction block may correspond to at least one among CU, PU and TU. A unit of a prediction block may have a size of one among CU, PU and TU. A prediction block may be a square block having a size of 2×2, 4×4, 16×16, 32×32 or 64×64 etc. or may be a rectangular block having a size of 2×8, 4×8, 2×16, 4×16 and 8×16 etc.

Intra prediction may be performed according to intra prediction mode for the current block. The number of intra prediction modes which the current block may have may be a fixed value and may be a value determined differently according to an attribute of a prediction block. For example, an attribute of a prediction block may comprise a size of a prediction block and a shape of a prediction block, etc.

The number of intra-prediction modes may be fixed to N regardless of a block size. Or, the number of intra prediction modes may be 3, 5, 9, 17, 34, 35, 36, 65, or 67 etc. Alternatively, the number of intra-prediction modes may vary according to a block size or a color component type or both. For example, the number of intra prediction modes may vary according to whether the color component is a luma signal or a chroma signal. For example, as a block size becomes large, a number of intra-prediction modes may increase. Alternatively, a number of intra-prediction modes of a luma component block may be larger than a number of intra-prediction modes of a chroma component block.

An intra-prediction mode may be a non-angular mode or an angular mode. The non-angular mode may be a DC mode or a planar mode, and the angular mode may be a prediction mode having a specific direction or angle. The intra-prediction mode may be expressed by at least one of a mode number, a mode value, a mode numeral, a mode angle, and mode direction. A number of intra-prediction modes may be M, which is larger than or equal to 1, including the non-angular and the angular mode.

In order to intra-predict a current block, a step of determining whether or not samples included in a reconstructed neighbor block may be used as reference samples of the current block may be performed. When a sample that is not usable as a reference sample of the current block is present, a value obtained by duplicating or performing interpolation on at least one sample value among samples included in the reconstructed neighbor block or both may be used to replace with a non-usable sample value of a sample, thus the replaced sample value is used as a reference sample of the current block.

When intra-predicting, a filter may be applied to at least one of a reference sample and a prediction sample based on an intra-prediction mode and a current block size.

In case of a planar mode, when generating a prediction block of a current block, according to a position of a prediction target sample within a prediction block, a sample value of the prediction target sample may be generated by using a weighted sum of an upper and left side reference sample of a current sample, and a right upper side and left lower side reference sample of the current block. In addition, in case of a DC mode, when generating a prediction block of a current block, an average value of upper side and left side reference samples of the current block may be used. In addition, in case of an angular mode, a prediction block may be generated by using an upper side, a left side, a right upper side, and/or a left lower side reference sample of the current block. In order to generate a prediction sample value, interpolation of a real number unit may be performed.

An intra-prediction mode of a current block may be entropy encoded/decoded by predicting an intra-prediction mode of a block present adjacent to the current block. When intra-prediction modes of the current block and the neighbor block are identical, information that the intra-prediction modes of the current block and the neighbor block are identical may be signaled by using predetermined flag information. In addition, indicator information of an intra-prediction mode that is identical to the intra-prediction mode of the current block among intra-prediction modes of a plurality of neighbor blocks may be signaled. When intra-prediction modes of the current block and the neighbor block are different, intra-prediction mode information of the current block may be entropy encoded/decoded by performing entropy encoding/decoding based on the intra-prediction mode of the neighbor block.

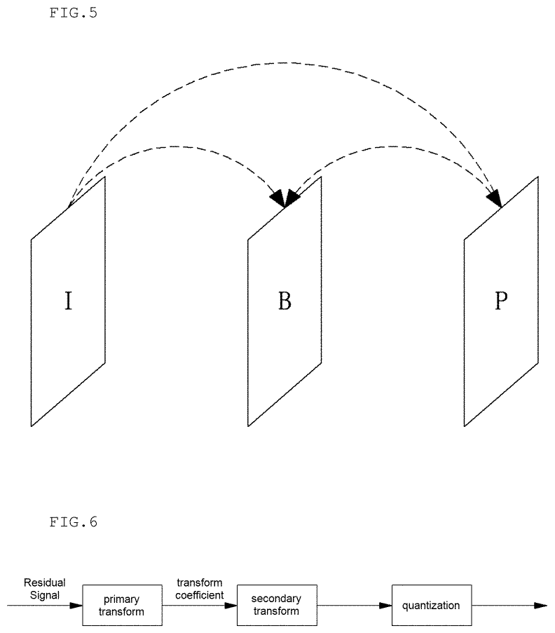

FIG. 5 is a diagram illustrating an embodiment of an inter-picture prediction process.

In FIG. 5, a rectangle may represent a picture. In FIG. 5, an arrow represents a prediction direction. Pictures may be categorized into intra pictures (I pictures), predictive pictures (P pictures), and Bi-predictive pictures (B pictures) according to the encoding type thereof.

The I picture may be encoded through intra-prediction without requiring inter-picture prediction. The P picture may be encoded through inter-picture prediction by using a reference picture that is present in one direction (i.e., forward direction or backward direction) with respect to a current block. The B picture may be encoded through inter-picture prediction by using reference pictures that are preset in two directions (i.e., forward direction and backward direction) with respect to a current block. When the inter-picture prediction is used, the encoder may perform inter-picture prediction or motion compensation and the decoder may perform the corresponding motion compensation.

Hereinbelow, an embodiment of the inter-picture prediction will be described in detail.

The inter-picture prediction or motion compensation may be performed using a reference picture and motion information.

Motion information of a current block may be derived during inter-picture prediction by each of the encoding apparatus 100 and the decoding apparatus 200. The motion information of the current block may be derived by using motion information of a reconstructed neighboring block, motion information of a collocated block (also referred to as a col block or a co-located block), and/or a block adjacent to the co-located block. The co-located block may mean a block that is located spatially at the same position as the current block, within a previously reconstructed collocated picture (also referred to as a col picture or a co-located picture). The co-located picture may be one picture among one or more reference pictures included in a reference picture list.

A method of deriving the motion information of the current block may vary depending on a prediction mode of the current block. For example, as prediction modes for inter-picture prediction, there may be an AMVP mode, a merge mode, a skip mode, a current picture reference mode, etc. The merge mode may be referred to as a motion merge mode.

For example, when the AMVP is used as the prediction mode, at least one of motion vectors of the reconstructed neighboring blocks, motion vectors of the co-located blocks, motion vectors of blocks adjacent to the co-located blocks, and a (0, 0) motion vector may be determined as motion vector candidates for the current block, and a motion vector candidate list is generated by using the emotion vector candidates. The motion vector candidate of the current block can be derived by using the generated motion vector candidate list. The motion information of the current block may be determined based on the derived motion vector candidate. The motion vectors of the collocated blocks or the motion vectors of the blocks adjacent to the collocated blocks may be referred to as temporal motion vector candidates, and the motion vectors of the reconstructed neighboring blocks may be referred to as spatial motion vector candidates.

The encoding apparatus 100 may calculate a motion vector difference (MVD) between the motion vector of the current block and the motion vector candidate and may perform entropy encoding on the motion vector difference (MVD). In addition, the encoding apparatus 100 may perform entropy encoding on a motion vector candidate index and generate a bitstream. The motion vector candidate index may indicate an optimum motion vector candidate among the motion vector candidates included in the motion vector candidate list. The decoding apparatus may perform entropy decoding on the motion vector candidate index included in the bitstream and may select a motion vector candidate of a decoding target block from among the motion vector candidates included in the motion vector candidate list by using the entropy-decoded motion vector candidate index. In addition, the decoding apparatus 200 may add the entropy-decoded MVD and the motion vector candidate extracted through the entropy decoding, thereby deriving the motion vector of the decoding target block.

The bitstream may include a reference picture index indicating a reference picture. The reference picture index may be entropy-encoded by the encoding apparatus 100 and then signaled as a bitstream to the decoding apparatus 200. The decoding apparatus 200 may generate a prediction block of the decoding target block based on the derived motion vector and the reference picture index information.

Another example of the method of deriving the motion information of the current block may be the merge mode. The merge mode may mean a method of merging motion of a plurality of blocks. The merge mode may mean a mode of deriving the motion information of the current block from the motion information of the neighboring blocks. When the merge mode is applied, the merge candidate list may be generated using the motion information of the reconstructed neighboring blocks and/or the motion information of the collocated blocks. The motion information may include at least one of a motion vector, a reference picture index, and an inter-picture prediction indicator. The prediction indicator may indicate one-direction prediction (L0 prediction or L1 prediction) or two-direction predictions (L0 prediction and L1 prediction).

The merge candidate list may be a list of motion information stored. The motion information included in the merge candidate list may be at least either one of the zero merge candidate and new motion information that is a combination of the motion information (spatial merge candidate) of one neighboring block adjacent to the current block, the motion information (temporal merge candidate) of the collocated block of the current block, which is included within the reference picture, and the motion information exiting in the merge candidate list.

The encoding apparatus 100 may generate a bitstream by performing entropy encoding on at least one of a merge flag and a merge index and may signal the bitstream to the decoding apparatus 200. The merge flag may be information indicating whether or not to perform the merge mode for each block, and the merge index may be information indicating that which neighboring block, among the neighboring blocks of the current block, is a merge target block. For example, the neighboring blocks of the current block may include a left neighboring block on the left side of the current block, an upper neighboring block disposed above the current block, and a temporal neighboring block temporally adjacent to the current block.

The skip mode may be a mode in which the motion information of the neighboring block is applied to the current block as it is. When the skip mode is applied, the encoding apparatus 100 may perform entropy encoding on information of the fact that the motion information of which block is to be used as the motion information of the current block to generate a bit stream, and may signal the bitstream to the decoding apparatus 200. The encoding apparatus 100 may not signal a syntax element regarding at least any one of the motion vector difference information, the encoding block flag, and the transform coefficient level to the decoding apparatus 200.

The current picture reference mode may mean a prediction mode in which a previously reconstructed region within a current picture to which the current block belongs is used for prediction. Here, a vector may be used to specify the previously-reconstructed region. Information indicating whether the current block is to be encoded in the current picture reference mode may be encoded by using the reference picture index of the current block. The flag or index indicating whether or not the current block is a block encoded in the current picture reference mode may be signaled, and may be deduced based on the reference picture index of the current block. In the case where the current block is encoded in the current picture reference mode, the current picture may be added to the reference picture list for the current block so as to be located at a fixed position or a random position in the reference picture list. The fixed position may be, for example, a position indicated by a reference picture index of 0, or the last position in the list. When the current picture is added to the reference picture list so as to be located at the random position, the reference picture index indicating the random position may be signaled.

FIG. 6 is a diagram illustrating a transform and quantization process.

As illustrated in FIG. 6, a transform and/or quantization process is performed on a residual signal to generate a quantized level signal. The residual signal is a difference between an original block and a prediction block (i.e., an intra prediction block or an inter prediction block). The prediction block is a block generated through intra prediction or inter prediction. The transform may be a primary transform, a secondary transform, or both. The primary transform of the residual signal results in transform coefficients, and the secondary transform of the transform coefficients results in secondary transform coefficients.

At least one scheme selected from among various transform schemes which are preliminarily defined is used to perform the primary transform. For example, examples of the predefined transform schemes include discrete cosine transform (DCT), discrete sine transform (DST), and Karhunen-Loève transform (KLT). The transform coefficients generated through the primary transform may undergo the secondary transform. The transform schemes used for the primary transform and/or the secondary transform may be determined according to coding parameters of the current block and/or neighboring blocks of the current block. Alternatively, the transform scheme may be determined through signaling of transform information.

Since the residual signal is quantized through the primary transform and the secondary transform, a quantized-level signal (quantization coefficients) is generated. The quantized level signal may be scanned according to at least one of a diagonal up-right scan, a vertical scan, and a horizontal scan, depending on an intra prediction mode of a block or a block size/shape. For example, as the coefficients are scanned in a diagonal up-right scan, the coefficients in a block form change into a one-dimensional vector form. Aside from the diagonal up-right scan, the horizontal scan of horizontally scanning a two-dimensional block form of coefficients or the vertical scan of vertically scanning a two-dimensional block form of coefficients may be used depending on the intra prediction mode and/or the size of a transform block. The scanned quantized-level coefficients may be entropy-encoded to be inserted into a bitstream.

A decoder entropy-decodes the bitstream to obtain the quantized-level coefficients. The quantized-level coefficients may be arranged in a two-dimensional block form through inverse scanning. For the inverse scanning, at least one of a diagonal up-right scan, a vertical scan, and a horizontal scan may be used.

The quantized-level coefficients may then be dequantized, then be secondary-inverse-transformed as necessary, and finally be primary-inverse-transformed as necessary to generate a reconstructed residual signal.

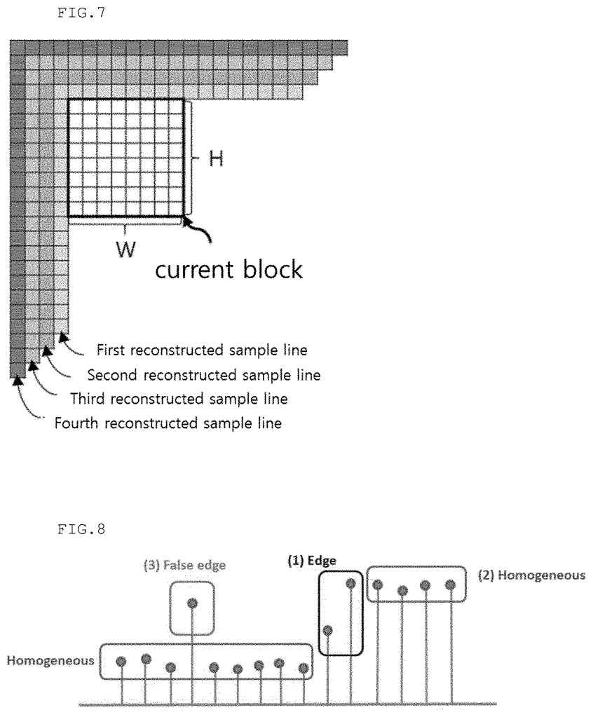

Hereinafter, a method of configuring a reference sample of intra-prediction described with reference to FIG. 7 will be described in detail.

When performing intra-prediction for a current block or for a sub-block having a size or form or both smaller than a current block on the basis of a derived intra-prediction mode, the encoder/decoder may configure a reference sample used for performing prediction. In the below description, a current block may mean a current sub-block.

A reference sample may be configured with at least one sample included in at least one reconstructed sample line shown in FIG. 7 or by combining samples. Herein, the encoder/decoder may use each of reconstructed samples in a plurality of reconstructed sample lines as it is, or may use as a reference sample after performing filtering between samples which are on the same reconstructed sample line or performing filtering between samples which are on different reconstructed sample lines.

When a reference sample is configured by selecting at least one line among a plurality of reconstructed sample lines of FIG. 7, an indicator of the selected reconstructed sample line may be signaled from the encoder to the decoder.

Alternatively, a statistic value of a plurality of reconstructed samples selected from a plurality of reconstructed sample lines of FIG. 7 may be calculated on the basis of at least one of a distance to a current block or an intra-prediction mode of the current block, and the calculated statistic value may be used as a reference sample.

In an example, when a statistic value is calculated by using a weighted sum, a weight of the weighted sum may be adaptively determined according to a distance from a current block to a reference sample line.

In an example, when a statistic value is calculated by using a weighted sum, a weight of the weighted sum may be adaptively determined according to an intra-prediction mode of a current block.

Meanwhile, at least one of a number of reconstructed sample lines, a position, and a configuration method which are used for configuring a reference sample may be determined by whether or not an upper or left boundary of a current block corresponds to at least one of a picture, a slice, a tile, and a coding tree block (CTB).

In an example, when an upper boundary of a current block corresponds to at least one of a picture, a slice, a tile, and a CTB, a reference sample may be configured as described in Table 1 below.

TABLE 1

| selected | | |
|---|---|---|
| reconstruction | | |
| sample line | upper side | left side |
| 1, 2 | 1 | 1, 2 |
| 1, 2, 3, 4 | 1, 2 | 1, 2, 3, 4 |
| 2 | 1 | 2 |

Meanwhile, information of configuring a reference sample may be signaled.

For example, at least one of information representing whether or not a plurality of reconstructed sample lines is used, and information of a selected reconstructed sample line may be signaled.

A neighbor reconstructed sample used for configuring a reference sample for intra-prediction may be configured as a reference sample by determining whether or not the neighbor reconstructed sample is available.

In an example, when a neighbor reconstructed sample is not positioned outside of an area of at least one of a picture, a slice, a tile, and a CTU where a current block is included, it may be determined not to be available.

In an example, when constrained intra-prediction is performed for a current block or a neighbor reconstructed sample is positioned in a block that is encoded/decoded by inter-prediction, it may be determined not to be available.

Meanwhile, when a neighbor reconstructed sample is determined not to be available, the encoder/decoder may replace a sample that is determined not to be available by using an available neighbor reconstructed sample.

In an example, by using one available reconstructed sample adjacent to a non-available sample or by using a statistic value of a plurality of available reconstructed samples, replacing the non-available sample may be performed. Herein, when a non-available sample is continuously present, an available reconstructed sample used for replacing may be at least one available reconstructed sample adjacent to the front and the rear of the continuous non-available sample.

When a current block is divided into a plurality of sub-blocks and each sub-block has a separate intra-prediction mode, a reference sample may be configured for each sub-block. Herein, according to a scanning order that predicts a plurality of sub-blocks, at least one reconstructed sub-block that is adjacent to left, upper, right-upper, and left-lower sides of a sub-block to be predicted may be used. Herein, a scanning order may be at least one of raster scanning, Z-scanning, zigzag scanning, vertical scanning, and horizontal scanning.

Hereinafter, performing of filtering for a reference sample for intra-prediction will be described in detail.

Whether or not to perform filtering may be determined on the basis of at least one of a block size, a block form, an intra-prediction mode, a division depth, and a pixel component.

According to an embodiment of the present invention, whether or not to perform filtering for a reference sample may be determined on the basis of a size of a current block. Herein, a size N (herein, N is a positive integer) of a current block may be defined by at least one of a horizontal (W) size of a block, a vertical (H) size of the block, the sum of horizontal and vertical sizes of the block (W+H), and a number of pixels within the block (W×H).

In an example, filtering may be performed when a size N of a current block is equal to or greater than a predetermined value T (herein, T is a positive integer).

In another example, filtering may be performed when a size N of a current block is equal to or smaller than a predetermined value T (herein, T is a positive integer).

In another example, filtering may be performed when a size N of a current block is equal to or greater than a predetermined value T1 and equal to or smaller than T2. (Herein, T1 and T2 are positive integers, and T2>T1)

In another example, filtering may be performed when a size N of a current block is equal to or smaller than a predetermined value T1 and equal to or greater than T2. (Herein, T1 and T2 are positive integers, and T2>T1)

According to an embodiment of the present invention, whether or not to perform filtering for a reference sample may be determined on the basis of a form of a current block. Herein, a block form may include a square block and a non-square block. In addition, a non-square block may be classified into a horizontally long non-square block and a vertically long non-square block.

In an example, filtering may be performed when a current block is a square block.

In another example, filtering may be performed when a current block is a non-square block.

Meanwhile, when a current block is a non-square block, whether or not to perform filtering for upper and left reference samples may be determined on the basis of a horizontal value (W) of a current block or a vertical value (H) of the current block.

In an example, whether or not to perform filtering for an upper reference sample may be determined according to a horizontal value (W) of a current block, and whether or not to perform filtering for a left reference sample may be determined according to a vertical value (H) of the current block.

In another example, whether or not to perform filtering for upper and left reference samples may be determined on the basis of a value greater between a horizontal value (W) of a current block and a vertical value (H) of the current block.

In another example, whether or not to perform filtering for upper and left reference samples may be determined on the basis of a value smaller between a horizontal value (W) of a current block and a vertical value (H) of the current block.

According to an embodiment of the present invention, whether or not to perform filtering for a reference sample may be determined on the basis of an intra-prediction mode of a current block.

In an example, filtering may be performed for a PLANAR or DC mode or both, which are non-directional modes.

In another example, filtering may not be performed for a PLANAR or DC mode or both, which are non-directional modes.

In another example, for a vertical or horizontal mode or both among directional modes, filtering may not be performed for all block sizes.

When an intra-prediction mode of a current block is defined as CurMode, a number or index of a horizontal directional mode is defined as Hor_Idx, and a number or index of a vertical directional mode is defined as Ver_Idx, reference sample filtering may be performed for CurMode satisfying when min{abs (CurMode−Hor_Idx), abs (CurMode−Ver_Idx)}>Th. Herein, a threshold value Th may be an arbitrary positive integer, and may be a value adaptively determined according to a size of the current block. In an example, when a size of a current block becomes large, a threshold value Th may become small. When min{abs(CurMode−Hor_Idx), abs(CurMode−Ver_Idx)}>Th, reference sample filtering is performed, and thus the min{abs(CurMode−Hor_Idx), abs(CurMode−Ver_Idx)}>Th may mean a condition for performing of reference sample filtering according to an intra-prediction mode. In other words, reference sample filtering may be performed when the above condition is satisfied.

Whether or not to perform reference sample filtering may be determined according to a division depth of a current block.

Whether or not to perform reference sample filtering may be determined according to a pixel component of a current block. Herein, a pixel component may include at least one of a luma component and a chroma component (Chroma, in an example, Cb and Cr).

In an example, reference sample filtering may be performed for a luma component, and reference sample filtering may not be performed for a chroma component.

Meanwhile, reference sample filtering may be performed for all components regardless of a luma component and a chroma component.

As described in above, whether or not to perform final filtering for an upper or left reference sample or both of a current block may be determined by combining each filtering performing condition based on at least one of a size, a form, an intra-prediction mode, a division depth, and a pixel component of a current block.

A filter type may be determined on the basis of at least one of an image feature, a block size, a block form, an intra-prediction mode, a division depth, whether or not a condition of performing reference sample filtering according to an intra-prediction mode is satisfied, and a pixel component. Herein, a filter type may mean a filter form.

A filter type may be determined as any one of an n-tap filter, a linear filter, a non-linear filter, a bilateral filter, a smoothing filter, edge-preserving filter, and an order-statistic filter. At least one of a filter length, a number of filter tabs, and a filter coefficient may be preset according to a filter type. N may mean a positive integer.

A filter type may be determined on the basis of an image feature of an area where a reference sample is included. Herein, an image feature may be determined as any one of a homogeneous area, an edge area, and a false edge area. An image feature may be determined on the basis of a degree of homogeneity of an image or a degree of texture of an image. An image degree of homogeneity and an image degree of texture may be an indicator having the opposite meaning, and the image degree of homogeneity may be calculated as K*[1/image degree of texture] (K is a positive integer).

FIG. 8 is a view showing an image feature of an area where a reference sample is included.

Referring to FIG. 8, when an image feature of an area where a reference sample is included is (1) an edge area, a filter type may be determined as an edge-preserving filter. Herein, an edge area may be a boundary area.

When an image feature of an area including a reference sample is (2) a homogeneous area, a filter type may be determined as a smoothing filter.

When an image feature of an area including a reference sample is (3) a false edge area, a reference sample may be determined as noise and a filtering exception process may be performed.

A method of determining a noise pixel among pixels to be filtered may be one of the below.

In a method of determining noise according to an embodiment of the present invention, a case where an absolute value of the difference between statistic values of N target pixel values which are adjacent to a current target pixel value is greater than a predetermined threshold value Th, the current target pixel may be determined as a noise pixel. Herein, N and Th may be a positive integer, and a statistic value may be any one of an average value, a median value, a maximum value, and a minimum value.

In an example, when a reference sample (or current target pixel) value is defined as Vcur, a value of an target pixel immediately prior to the reference sample (or current target pixel) is defined as Vpre, and a value of an target pixel immediately after the reference sample (or current target pixel) is defined as Vaft, and filtering is performed for a 1D line, the reference sample (or current target pixel) may be determined as a noise pixel when the following is satisfied: (Vcur−Vpre)*(Vafr−Vcur)<0 and max{abs(Vcur−Vpre), abs(Vafr−Vcur)}>=Th. Herein, Th may be a positive integer satisfying Th>=0.

In an example, when a reference sample (or current target pixel) value is defined as Vcur, respective values of N target pixels adjacent to the reference sample (or current target pixel) are defined as Vi (herein, i=1, 2, . . . , N, and N is a positive integer), and filtering is performed for a 2D line, the reference sample (or current target pixel) may be determined as a noise pixel when the following is satisfied: for all N, Vcur−Vi> or Vcur−Vi<0, and max{abs(Vcur−V1), abs(Vcur−V2), . . . , abs(Vafr−VN)}>=Th. Herein, Th may be a positive integer satisfying Th>=0.

Meanwhile, a reference sample (or a target pixel for which filtering is performed) that is determined as noise when performing filtering may be processed as any one of below. In an example, filtering may not be performed for a noise target pixel. In another example, filtering may be performed after excluding a noise target pixel from a target area for which filtering is performed.

As described above, when performing filtering taking into account of an image feature of an area where a reference sample is included, prediction efficiency may be increased as a prediction block is generated by using a reference sample that is close to an original image. Particularly, a residual signal value may be decreased as an edge-preserving filter is possibly applied to an edge area. In addition, ringing artifacts in an object boundary area of an image, and contour artifacts occurring when performing directional prediction may be improved.

An image degree of homogeneity or image degree of texture used when determining an image feature may be derived as below.

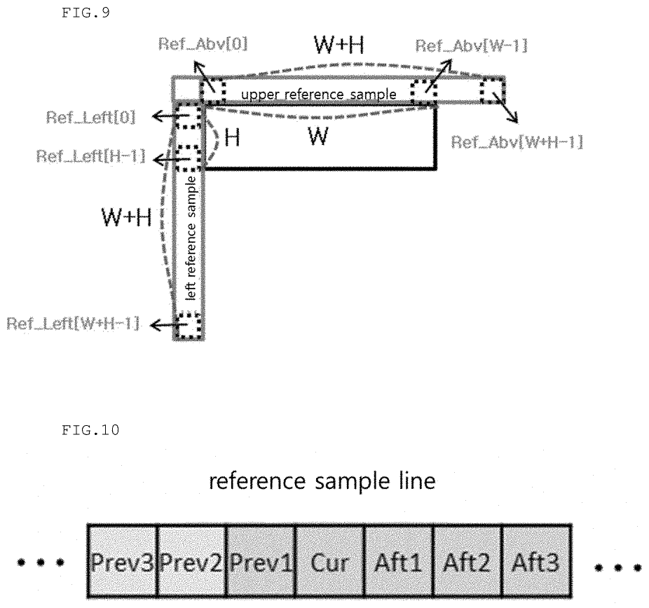

In an example, an image degree of homogeneity for an upper or left reference sample of the image may be separately derived in a block of FIG. 9 by using at least one of formulas below, or may be derived for both of left and upper reference samples.

A degree of homogeneity of an upper (above) reference sample may be derived by using Formula 1 or Formula 2.

$$\begin{matrix}Homogeneity\_Above = abs ( Ref\_Abv [ 0 ] - 2 \cdot Ref\_Abv [ \frac{W}{2} ] + Ref\_Abv [ W - 1 ] ) & [ Formula 1 ] \\ Homogeneity\_Above = abs ( Ref\_Abv [ 0 ] - 2 \cdot Ref\_Abv [ \frac{W + H}{2} ] + Ref\_Abv [ W + H - 1 ] ) & [ Formula 2 ]\end{matrix}$$

A degree of homogeneity of a left reference sample may be derived by using Formula 3 or Formula 4.

$$\begin{matrix}Homogeneity\_Left = abs ( Ref\_Left [ 0 ] - 2 \cdot Ref\_Left [ \frac{H}{2} ] + Ref\_Left [ H - 1 ] ) & [ Formula 3 ] \\ Homogeneity\_Left = abs ( Ref\_Left [ 0 ] - 2 \cdot Ref\_Left [ \frac{W + H}{2} ] + Ref\_Left [ W + H - 1 ] ) & [ Formula 4 ]\end{matrix}$$

Alternatively, the entire degree of homogeneity of a current block may be derived by using a weighted sum of the left side degree of homogeneity and the upper side degree of homogeneity calculated as above.

As another example of calculating an image degree of homogeneity, a degree in change or gradient of a reference pixel may be used.

In an example, as shown in FIG. 10, a gradient (Pixel Gradient) in a reference pixel (Cur) that is currently filtered may be derived as Formula 5 or Formula 6. Herein, in Formula 5 or Formula 6, N may be an arbitrary positive integer, and Wk in Formula 6 may be an arbitrary real number.

$$\begin{matrix}Pixel\_Gradient = abs ( Prev\_N - Aft\_N ) & [ Formula 5 ] \\ Pixel\_Graident = \frac{1}{N} \cdot {\sum }_{k = 1}^{N} {W}_{k} \cdot abs ( Prev\_k - Aft\_k ) & [ Formula 6 ]\end{matrix}$$

When a number of upper reference samples or left reference samples or upper and left reference samples is M (that is, M is W, H, W+H, or W×H), an average gradient of the entire reference sample group is calculated as Formula 7.

$$Mean\_Gradient = \frac{1}{M} \sum Pixel\_Gradient , \\ where M = W or H or W + H \qquad [ Formula 7 ]$$

When applying filtering for a plurality of reference sample lines, each degree of homogeneity may be derived for each line, or a weighted sum of degrees of homogeneity calculated in respective sample lines may be used as the entire degree of homogeneity.

A filter type may be determined on the basis of a pixel component of a current block.

In an example, a filter type of a chroma component may be set to be identical to a filter type of a luma component.

Meanwhile, a filter type of a luma component and a filter type of chroma component may be independently determined.

At least one of a filter length and a filter coefficient may be determined according to a filter type. However, even though a filter type used for reference sample filtering is determined, at least one of a filter length and a filter coefficient may be adaptively changed.

A filter length may be determined on the basis of at least one of an image feature, a block size, a block form, an intra-prediction mode and a division depth, whether or not to perform reference sample filtering, whether or not a condition for performing reference sample filtering according to an intra-prediction mode is satisfied, and a pixel component. Herein, a filter length may mean a number of filter taps.

According to an embodiment of the present invention, a filter length applied to reference sample filtering may be determined on the basis of a size of a current block. Herein, a size N (herein, N is a positive integer) of a current block may be defined as at least one of a horizontal (W) size of a block, a vertical (H) size of the block, the sum of horizontal and vertical sizes of the block (W+H), and a number of pixels within the block (W×H). Herein, a reference sample may mean at least one of an upper reference sample and a left reference sample.

A filter length may be adaptively determined according to a value of a block size N.

In an example, and an N value is smaller than Th_1, filtering of a L_1 length may be applied, when an N value is equal to or greater than Th_1 and smaller than Th_2, filtering of a L_2 length may be applied, and when an N value is equal to or greater than Th_(K−1) and smaller than Th_K, filtering of a L_K length may be applied. Herein, L_1 to L_K may be a positive integer satisfying L_1<L_2< . . . <L_K, and Th_1 to Th_K may be a positive integer satisfying Th_1<Th_2< . . . <Th_K. Alternatively, L_1 to L_K may be a positive integer satisfying L_1<L_2< . . . <L_K, and Th_1 to Th_K may be a positive integer satisfying Th_K<Th_K−1< . . . <Th_1.

Meanwhile, a fixed filter length may be used regardless of a value of a block size N.

When applying filtering to a plurality of reference sample lines, a filter length determined according to the above condition may be identically applied to all reference sample lines, or an independent filter length may be applied to each sample line.

In an example, a filter length to be applied to the first upper or left reference sample line or both may be determined according to the condition described above, and a filter length to be applied to the second upper or left reference sample line or both may be determined as a filter length decreased by the filter length applied to the first reference sample line. Conversely, a filter length of the second and subsequent upper or left reference sample line or both may be determined as a filter length increased by a filter length applied to the first reference sample line.

According to an embodiment of the present invention, a filter length applied to reference sample filtering may be determined on the basis of an image feature of an area where a reference sample is included. Description of an image feature will be omitted since the same is described in detail above.

In detail, a filter length applied to an upper or left reference sample or both may be adaptively determined according to a degree of homogeneity of an area where a reference sample is included.

In an example, when a value of a degree of homogeneity is smaller than Th_1, filtering of a L_1 length may be applied, when a value of a degree of homogeneity value is equal to or greater than Th_1 and smaller than Th_2, filtering of a L_2 length may be applied, when a value of a degree of homogeneity value is equal to or greater than Th_(K−1) and smaller than Th_K, filtering of a L_K length may be applied. Herein, L_1 to L_K may be a positive integer satisfying L_1<L_2< . . . <L_K, and Th_1 to Th_K may be a positive integer satisfying Th_1<Th_2< . . . <Th_K. Alternatively, L_1 to L_K may be a positive integer satisfying L_1<L_2< . . . <L_K, and Th_1 to Th_K may be a positive integer satisfying Th_K<Th_K−1< . . . <Th_1. K may be a predetermined positive integer.

Meanwhile, a fixed filter length may be used regardless of a value of a degree of homogeneity of an area where a reference sample is included.

According to an embodiment of the present invention, a filter length applied to an upper or left reference sample or both may be determined on the basis of a form of a current block.

In an example, when a form of a current block is square (that is, when a horizontal (W) size of a current block and a vertical (H) size of the current block are identical), an identical length filter may be applied to an upper reference sample and a left reference sample. In addition, when a form of a current block is non-square, filters having lengths different from each other may be applied to an upper reference sample and a left reference sample.

In an example, when a horizontal (W) size of a current block is greater than a vertical (H) size of the current block, a filter length may be applied to an upper reference sample which is greater than a filter length applied to a left reference sample, and when horizontal (W) size of the current block is smaller than the vertical (H) size of the current block, a filter length may be applied to a left reference sample which is greater than a filter length applied to an upper reference sample.

In addition, a filter length applied to upper and left reference samples may be independently determined according to a horizontal (W) size of a current block and a vertical (H) size of the current block.

In addition, even though a form of a current block is square, filters having lengths different from each other may be applied to an upper reference sample and a left reference sample.

Meanwhile, an identical filter length may be applied to upper and left reference samples regardless of a block form.

According to an embodiment of the present invention, a filter length applied to an upper or left reference sample or both may be determined on the basis of an intra-prediction mode of a current block.

In an example, when an intra-prediction mode of a current block is one of vertical directional modes, a filter length may be applied to an upper reference sample which is greater than a filter length applied to a left reference sample. In addition, when an intra-prediction mode of a current block is one of horizontal directional modes, a filter length may be applied to a left reference sample which is greater than a filter length applied to an upper reference sample.

Conversely, when an intra-prediction mode of a current block is one of vertical directional modes, a filter length may be applied to a left reference sample which is greater than a filter length applied to an upper reference sample. In addition, when an intra-prediction mode of a current block is one of horizontal directional modes, a filter length may be applied to an upper reference sample which is greater than a filter length applied to a left reference sample.

Meanwhile, an identical filter length may be applied to upper and left reference samples regardless of an intra-prediction mode of a current block.

A filter length may be determined on the basis of a pixel component of a current block.

In an example, a filter length of a chroma component may be set to be identical to a filter length of a luma component.

Meanwhile, a filter length of a luma component and a filter length of chroma component may be independently determined.

A filter coefficient may be determined on the basis of at least one of an image feature, a block size, a block form, an intra-prediction mode and a division depth, whether or not to perform reference sample filtering, whether or not a condition for performing reference sample filtering according to an intra-prediction mode is satisfied, and a pixel component. Herein, a filter coefficient may mean a number of filter sets.

As described above, reference sample filtering for intra-prediction has been described in detail. A method of determining whether or not to perform filtering, a method of determining a filter type, a method of determining a filter length, and a method of determining a filter coefficient which are described above may be identically applied to, in addition to reference sample filtering for intra-prediction, steps below of the encoder of FIG. 1 or the decoder of FIG. 2
interpolation filtering in an intra-prediction unit, and boundary area filtering for an intra-prediction block
interpolation filtering for generating a prediction block in a motion compensation unit, and boundary area filtering for an inter-prediction block
interpolation filtering for generating a prediction block in a motion prediction unit
de-blocking filtering, SAO (sample adaptive offset) filtering, and ALF (adaptive loop filtering) in a filter unit
at least one filtering of OBMC (overlapped block motion compensation), FRUC (frame rate up conversion), and BIO (bi-directional optical flow) which are performed for correction (or refinement or fine-tuning) of motion information in the encoder or decoder

Accordingly, in the description below, filtering may mean at least one filtering of reference sample filtering/interpolation filtering/boundary area filtering in an intra-prediction unit, boundary area filtering for a interpolation filtered/generated prediction block generated for a prediction block in a motion prediction unit and a motion compensation unit, in-loop filtering in a filter unit, and OBMC, FRUC, and BIO for correction of motion information in the encoder and the decoder.

According to an embodiment of the present invention, at least one of whether or not to perform filtering, a filter type, a filter length, and a filter coefficient may be determined on the basis of at least one of a block size, a block form, a prediction mode, an intra-prediction mode, an inter-prediction mode, a local feature of an image, a global feature of an image, whether or not to perform reference sample filtering, whether or not a condition for performing reference sample filtering according to an intra-prediction mode is satisfied, a pixel component, and other coding parameter.

In an example, a filter type used in interpolation filtering in an intra-prediction unit may be determined on the basis of at least one of an image feature, a block size, a block form, an intra-prediction mode, a division depth, whether or not to perform reference sample filtering, whether or not a condition for performing reference sample filtering according to an intra-prediction mode is satisfied, and a pixel component.

In addition, a filter coefficient used in interpolation filtering in an intra-prediction unit may be determined on the basis of at least one of an image feature, a block size, a block form, an intra-prediction mode, a division depth, whether or not a condition for performing reference sample filtering according to an intra-prediction mode is satisfied, and a pixel component.

For example, when reference sample filtering is performed or a condition for performing reference sample filtering according to an intra-prediction mode is satisfied, a first filter coefficient set may be used during interpolation filtering. When reference sample filtering is not performed or a condition for performing reference sample filtering according to an intra-prediction mode is not satisfied, a second filter coefficient set may be used during interpolation filtering.

In other words, a filter coefficient may be determined from filter coefficient sets including at least one filter coefficient according to whether or not reference sample filtering is performed or a condition for performing reference sample filtering according to an intra-prediction mode is satisfied.

A filter coefficient set used in interpolation filtering in an intra-prediction unit may be a filter coefficient set to be identical to an interpolation filter coefficient set used when generating a luma or chroma prediction block in a motion compensation unit.

In addition, when filtering for a reference sample that becomes a target of interpolation filtering in an intra-prediction unit is not performed, interpolation filter coefficients different from each other may be used according to whether or not a condition for performing reference sample filtering according to an intra-prediction mode is satisfied.

In another example, when filtering for a reference sample that becomes a target of interpolation filtering in an intra-prediction unit is performed, interpolation filter coefficients different from each other may be used according to whether or not a condition for performing reference sample filtering according to an intra-prediction mode is satisfied.

Herein, a filter coefficient set may mean a set configured with K filter coefficients different from each other. In addition, K may be a positive integer. In addition, the filter coefficient set or the filter coefficient may mean an interpolation filter coefficient set or an interpolation filter coefficient.

Filtering according to an embodiment of the present invention may be applied to a pixel component including at least one of a luma component and a chroma component (for example, Cb, Cr) by using one of methods below.

In an example, filtering may be applied to a luma component, but not to a chroma component. Conversely, filtering may not be applied to a luma component, but applied to a chroma component. Meanwhile, filtering may be applied to both of a luma component and a chroma component.

In an example, identical filtering may be applied to a luma component and a chroma component. Meanwhile, different filtering may be applied to a luma component and a chroma component.

In an example, identical filtering may be applied to Cb and Cr of chroma components. Meanwhile, different filtering may be applied to Cb and Cr of chroma components.

Hereinafter, an application direction of filtering according to an embodiment of the present invention, and a pixel area used for filtering and a pixel unit applied to filtering will be described.

An application direction of filtering according to an embodiment of the present invention may be any one of a horizontal direction, a vertical direction, and a direction having an arbitrary angle.

FIG. 11 is a view showing a direction of applying filtering according to an embodiment of the present invention.

Referring to FIG. 11, (a) represents a horizontal direction, (b) represents a vertical direction, and (c) represents a direction having an arbitrary angle (⊖). Herein, ⊖ may be an integer or a real number.

Meanwhile, for a target pixel for which filtering is performed, filtering may be repeatedly or recursively applied by combining at least one of (a), (b), and (c) directions of FIG. 11.

A pixel area used for filtering according to an embodiment of the present invention may be any one of pixels positioned at a horizontal direction of a target pixel, pixels positioned at a vertical direction of a target pixel, pixels positioned at a plurality of horizontal direction lines including a target pixel, pixels positioned at a plurality of vertical direction lines including a target pixel, pixels within a cross-shaped area including a target pixel, and pixels within a geometrical area including a target pixel.

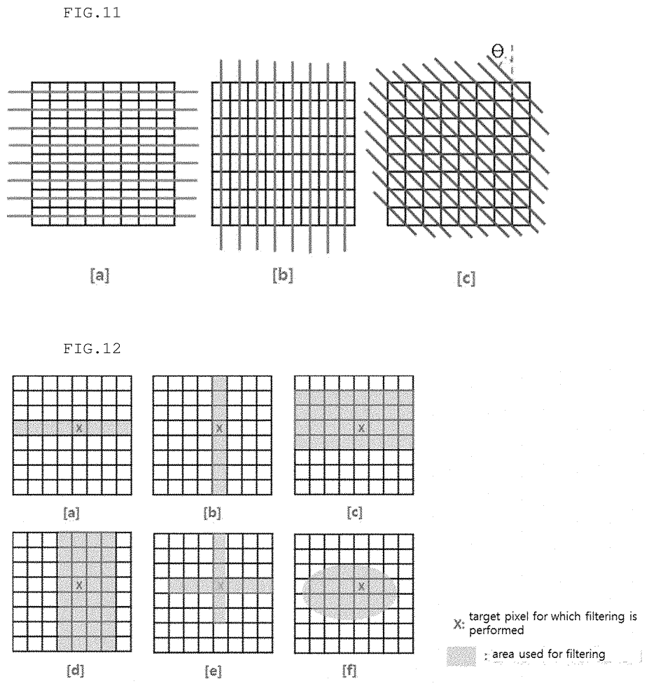

FIG. 12 is a view showing a pixel area used for filtering according to an embodiment of the present invention.

In an example, as shown in (a) of FIG. 12, filtering may be performed by using a target pixel and pixels positioned at a horizontal direction.

Alternatively, as shown in (b) of FIG. 12, filtering may be performed by using a target pixel and pixels positioned at a vertical direction.

Alternatively, as shown in (c) of FIG. 12, filtering may be performed by using pixels positioned at N horizontal directional lines including a target pixel. Herein, a horizontal directional line may be an upper or lower line or both of the target pixel. Herein, N may be a positive integer greater than 1. Meanwhile, when N is an odd number, horizontal directional lines may be positioned at upper and lower of the target pixel with the same number.

Alternatively, as shown in (d) of FIG. 12, filtering may be performed by using pixels positioned at N vertical directional lines including a target pixel. Herein, vertical directional lines may be left or right lines or both of the target pixel left. Herein, N may be a positive integer greater than 1. Meanwhile, when N is an odd number, vertical direction lines may be positioned at the left and the right of the target pixel left with the same number.

Alternatively, as shown in (e) of FIG. 12, filtering may be performed by using pixels within a cross-shaped area including a target pixel. Herein, when a vertical length of the cross-shaped area is M, and a horizontal length is N, M and N may be a positive integer greater than 2.

Alternatively, as shown in (f) of FIG. 12, filtering may be performed by using pixels within a geometrical area including a target pixel. Herein, the geometrical area may be at least one of a square, a non-square, a triangle, a trapezoid, and a circle.

Meanwhile, all pixels within a pixel area represented in a shadow form in (a) to (f) of FIG. 12 may be used for filtering, or filtering may be performed by using partial pixels among pixels within the area.

For example, filtering may be performed by using a target pixel (X) and consecutive pixels thereof among pixels within a pixel area are represented in a shadow form in (a) to (f) of FIG. 12. Alternatively, filtering may be performed by using pixels spaced apart from a target pixel (X) by a predetermined distance K (K is a positive integer).

A pixel unit of applying filtering according to an embodiment of the present invention may be an integer pixel unit (integer pel) or fractional pixel unit (fractional pel) or both. Herein, a fractional unit may be ½ (half-pel), ¼ (quarter-pel), ⅛ pel, 1/16 pel, 1/32 pel, 1/64 pel, . . . , and 1/N pel. Herein, N is a positive integer.

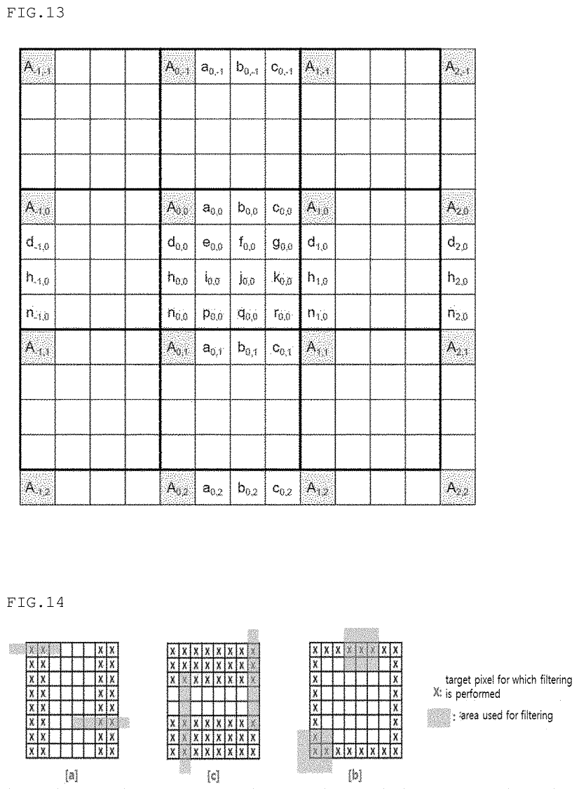

FIG. 13 is a view showing an embodiment example of applying filtering in a ¼ (or quarter-pel) unit.

In FIG. 13, a pixel represented in a shadow form with capital letter may represent a pixel at an integer position, and other pixels including pixels with lowercase letters may represent pixels at a fractional unit. In addition, i in “X_{i,j}” of FIG. 13 may represent an index of a horizontal direction, and j may represent an index of a vertical direction.

In FIG. 13, a pixel unit for applying filtering may be at least one of the below.
applying filtering to a pixel in an integer unit which is A_{i,j}
applying filtering to pixels in a ½ pel unit which are b_{i,j}, and h_{i,j}
applying filtering to pixels in a ¼ pel unit which are a_{i,j}, c_{i,j}, d_{i,j}, and n_{i,j}
applying filtering to pixels in a fractional unit present within four adjacent integer pixels forming a square which are e_{i,j}, f_{i,j}, g_{i,j}, i_{i,j}, j_{i,j}, k_{i,j}, p_{i,j}, q_{i,j}, and r_{i,j}

Meanwhile, a pixel used for filtering a target pixel in each pixel unit for which filtering is possibly performed may be an arbitrary combination of at least one direction to which filtering is applied of FIG. 11, and at least one area used for filtering of FIG. 12.

In below, n-tap filtering, smoothing filtering, edge-preserving filtering, 1D filtering, 2D filtering, and order-statistic filtering according to an embodiment of the present invention will be described in detail. Herein, n may be a positive integer.

Filtering using an n-tap filter according to an embodiment of the present invention may be performed by using Formula 8 below. Herein, a target pixel to which filtering is performed is X, a pixel used for filtering is {b₁, b₂, . . . , bₙ}, a filter coefficient is {c₁, c₂, . . . , cₙ}, a value of the target pixel after filtering is X′, and n is a positive integer.

$${X}^{′} = \{ {\sum }_{i = 1}^{n} {c}_{i} \cdot {b}_{i} + ( {\sum }_{i = 1}^{n} {c}_{i} ≫ 1 ) \} / {\sum }_{i = 1}^{n} {c}_{i} \qquad [ Formula 8 ]$$

In an example of performing filtering, when a target pixel to which filtering is performed is “b0, 0”, a length of the target pixel is 8, and an 8-tap filter in which a filter coefficient is {−1, 4, −11, 40, 40, −11, 4, −1} is applied, a filtered value may be calculated as Formula 9.

$${b}_{( 0 , 0 )} = \{ - 1 \times {A}_{( - 3 , 0 )} + 4 \times {A}_{( - 2 , 0 )} - 11 \times {A}_{( - 1 , 0 )} + 40 \times {A}_{( 0 , 0 )} + 40 \times {A}_{( 1 , 0 )} - 11 \times {A}_{( 2 , 0 )} + 4 \times {A}_{( 3 , 0 )} - 1 \times {A}_{( 4 , 0 )} + 32 \} / 64 \qquad [ Formula 9 ]$$

Meanwhile, for a target pixel X for which filtering is performed, when a part of an area used for filtering is positioned outside of a picture boundary, block boundary, or sub-block boundary as shown in an example of FIG. 14, filtering for the target pixel X may be performed by using any one of the below.
filtering is not performed for a target pixel X
filtering for a target pixel X is performed by using an area present inside a picture, block, or sub-block boundary which is used for performing filtering

A length of a smoothing filter according to an embodiment of the present invention may be an arbitrary positive integer. In addition, a coefficient (or filter coefficients) of a smoothing filter may be determined by using any one of the below.

In an example, a coefficient of a smoothing filter may be derived by using a Gaussian function. 1D and 2D Gaussian functions may be represented as Formula 10 below.

$$g ( x ) = \frac{1}{\sqrt{2 π} \cdot σ} \cdot {e}^{- \frac{{x}^{2}}{2 {σ}^{2}}} - 1 D \\ g ( x , y ) = \frac{1}{2 {πσ}^{2}} \cdot {e}^{- \frac{{x}^{2} + {y}^{2}}{2 {σ}^{2}}} - 2 D \\ σ \text{:} standard deviation \qquad [ Formula 10 ]$$

A filter coefficient may be a quantized value within a pixel range (0-2^{BitDepth}) derived from Formula 10.

In an example, when performing filtering by using a 1D Gaussian function by using a 4-tap length in a 1/32 pel unit, a filter coefficient applied to a target pixel at a position of each integer/fractional unit may be as Table 2 below. Herein, in Table 2, 0 may represent a pixel of an integer unit, filter coefficient from 17/32- 31/32 may be derived by performing symmetric for filter coefficients of 16/32- 1/32.

TABLE 2

| Position | 0 (Integer-Pel) | 1/32 | 2/32 | 3/32 | 4/32 | 5/32 | 6/32 | 7/32 | 8/32 |
|---|---|---|---|---|---|---|---|---|---|
| filter | (47, 161, | (4 [symbol] , 161, | (40, 160, | (37, [symbol] , | (34, 158, | (31, 156, | (28, 154, | (26, 153, | (25, 149, |
| coefficient | 47, 1) | 51, 1) | 54, 2) | 58, 2) | 62, 2) | 67, 2) | 72, 3) | 76, 3) | 80, 4) |

| Position | 9/32 | 10/32 | 11/32 | 12/32 | 13/32 | 14/32 | 15/32 | 16/32 |
|---|---|---|---|---|---|---|---|---|
| filter | (21, 146, | (19, 142, | (17, 139, | (16, 1 [symbol] , | (14, 1 [symbol] 1, | (13, 127, | (11, 123, | (10, 118, |
| coefficient | 85, 4) | 90, 5) | 94, 5) | 99, 6) | 104, 7) | 108, 8) | 113, 9) | 118, 10) |

[symbol]

indicates data missing or illegible when filed

In another example, when performing filtering by using a 1D Gaussian function by using a length of 4 in a 1/32 pel unit, a filter coefficient applied to a target pixel at a position of each inter/fractional unit may be as Table 3 below.

TABLE 3

| Position | 0 (Integer-Pel) | 1/32 | 2/32 | 3/32 | 4/32 | 5/32 | 6/32 | 7/32 | 8/32 |
|---|---|---|---|---|---|---|---|---|---|
| filter | (16, 32, | (15, 29, | (15, 29, | (14, 29, | (13, 29, | (13, 28, | (13, 28, | (12, 28, | (11, 28, |
| coefficient | 16, 0) | 17, 3) | 17, 3) | 18, 3) | 18, 4) | 19, 4) | 19, 4) | 20, 4) | 20, 5) |

| Position | 9/32 | 10/32 | 11/32 | 12/32 | 13/32 | 14/32 | 15/32 | 16/32 | 17/32 |
|---|---|---|---|---|---|---|---|---|---|
| filter | (11, 27, | (10, 27, | (9, 27, | (9, 26, | (9, 26, | (8, 25, | (8, 25, | (8, 24, | (7, 24, |
| coefficient | 21, 5) | 22, 5) | 22, 6) | 23, 6) | 23, 6) | 24, 7) | 24, 7) | 24, 8) | 25, 8) |
| Position | 18/32 | 19/32 | 20/32 | 21/32 | 22/32 | 23/32 | 24/32 | 25/32 | 26/32 |
| filter | (7, 24, | (6, 23, | (6, 23, | (6, 22, | (5, 22, | (5, 21, | (5, 20, | (4, 20, | (4, 19, |
| coefficient | 25, 8) | 26, 9) | 26, 9) | 27, 9) | 27, 10) | 27, 11) | 28, 11) | 28, 12) | 28, 13) |

| Position | 27/32 | 28/32 | 29/32 | 30/32 | 31/32 |
|---|---|---|---|---|---|
| filter | (4, 19, | (4, 18, | (3, 18, | (3, 17, | (3, 17, |
| coefficient | 28, 13) | 29, 13) | 29, 14) | 29, 15) | 29, 16) |

In Table 3, the total sum of filter coefficients may be represented by using M bits. Herein, the total sum of filter coefficients may not exceed 2<<M. For example, M may be a positive integer including 6. When M is 6, the total sum of filter coefficients may be exceed 64 that is 2<<6.

At least one of filter coefficients of Table 3 may mean at least one filter coefficient within the first filter coefficient set.

However, a filter coefficient that is possibly derived from a Gaussian function is not specified to a coefficient value described in Tables 2 and 3, and may be determined on the basis of a block size, a block form, an intra/inter-prediction mode, a local feature of an image, a global feature of an image, whether or not to perform reference sample filtering, whether or not a condition for performing reference sample filtering according to an intra-prediction mode is satisfied, a pixel component, and a coding parameter.

A filter coefficient within Tables 2 and 3 may be an example of an M-tap filter coefficient, and M may be a positive integer including 4.

A filter coefficient derived from the Gaussian function may be used for at least one of reference sample filtering/interpolation filtering/boundary area filtering in an intra-prediction unit, boundary area filtering for a prediction block filtered/generated for generating a prediction block in a motion prediction unit and a motion compensation unit, in-loop filtering in a filter unit, and OBMC, FRUC and BIO for correction of motion information in the encoder and the decoder.

In another example, a coefficient of a smoothing filter may be derived by using a DCT-based function. The DCT transform of forward and backward directions (including the fractional unit) may be represented as Formula 11 below.

$$F ( u ) = c ( u ) {\sum }_{l = 0}^{N - 1} p ( l ) cos ( \frac{( 2 l + 1 ) u π}{2 N} ) - Forward direction \\ p ( x ) = {\sum }_{u = 0}^{N - 1} c ( u ) F ( u ) cos ( \frac{( 2 x + 1 ) u π}{2 N} ) - backward direction \\ p ( {α}^{′} ) = {\sum }_{u = 0}^{N - 1} c ( u ) F ( u ) cos ( \frac{( 2 {α}^{′} + 1 ) u π}{2 N} ) - backward direction \\ N = Tap length \\ {α}^{′} = α + ( \frac{N}{2} - 1 ) \\ c ( 0 ) = \frac{1}{\sqrt{N}} , c ( k ) = \sqrt{\frac{2}{N}} , k = 1 , … N - 1 \\ α \text{:} Fractional Point \qquad [ Formula 11 ]$$

A filter coefficient may be a quantized value within a pixel range (0-2^{BitDepth}) derived from the above Formula.

In an example, in FIG. 13, a filter coefficient applied to a fractional unit of ¼, ½, ¾, etc. may be as below.
hₐ^{y}(n)=[−1, 4, −10, 58, 17, −5, 1], n=−3, . . . , 3
h_{b}^{y}(n)=[−1, 4, −11, 40, 40, −11, 4, −1], n=−3, . . . , 4
h_{c}^{y}(n)=hₐ^{y}(−n)

In another example, when performing filtering by using DCT-based function using a 4-tap length in a 1/32 pel unit, a filter coefficient applied to a target pixel at a position of each integer/fractional unit may be as Table 4 below.

TABLE 4

| Position | 0 (Integer-Pel) | 1/32 | 2/32 | 3/32 | 4/32 | 5/32 | 6/32 | 7/32 | 8/32 |
|---|---|---|---|---|---|---|---|---|---|
| filter | [symbol] | [symbol] | [symbol] | [symbol] | [symbol] | [symbol] | [symbol] | [symbol] | [symbol] |
| coefficient | | | | | | | | | |

| Position | 9/32 | 10/32 | 11/32 | 12/32 | 13/32 | 14/32 | 15/32 | 16/32 | 17/32 |
|---|---|---|---|---|---|---|---|---|---|
| filter | [symbol] | [symbol] | [symbol] | [symbol] | [symbol] | [symbol] | [symbol] | [symbol] | [symbol] |
| coefficient | | | | | | | | | |
| Position | 18/32 | 19/32 | 20/32 | 21/32 | 22/32 | 23/32 | 24/32 | 25/32 | 26/32 |
| filter | [symbol] | [symbol] | [symbol] | [symbol] | [symbol] | [symbol] | [symbol] | [symbol] | [symbol] |
| coefficient | | | | | | | | | |

| Position | 27/32 | 28/32 | 29/32 | 30/32 | 31/32 |
|---|---|---|---|---|---|
| filter | [symbol] | [symbol] | [symbol] | [symbol] | [symbol] |
| coefficient | | | | | |

[symbol]

indicates data missing or illegible when filed

In Table 4, the total sum of filter coefficients may be represented by using M bits. Herein, the total sum of filter coefficients may not exceed 2<<M. For example, M may be a positive integer including 6. When M is 6, the total sum of filter coefficients may be exceed 64 that is 2<<6.

At least one of filter coefficients of Table 4 may mean at least one filter coefficient within the first filter coefficient set.

However, a filter coefficient that is possibly derived from a DCT-based function is not specified to the coefficient value and Table 4, and may be determined on the basis of a block size, a block form, an intra/inter-prediction mode, a local feature of an image, a global feature of an image, whether or not to perform reference sample filtering, whether or not a condition for performing reference sample filtering according to an intra-prediction mode is satisfied, a pixel component, and a coding parameter.

The coefficient value and the filter coefficient of Table 4 may be an example of an M-tap filter coefficient, and M may be a positive integer including 4.

A filter coefficient derived from the DCT-based function may be used for at least one of reference sample filtering/interpolation filtering/boundary area filtering in an intra-prediction unit, boundary area filtering for a prediction block filtered/generated for generating a prediction block in a motion prediction unit and a motion compensation unit, in-loop filtering in a filter unit, and OBMC, FRUC and BIO for correction of motion information in the encoder and the decoder.

In another example, a coefficient of a smoothing filter may be derived from a median filter. Herein, a median filter may be a filter using as a filtered value a median value among pixel values within an area used for filtering a target pixel.

A length of an edge-preserving filter according to an embodiment of the present invention may be an arbitrary positive integer. In addition, a coefficient (or filter coefficients) of an edge-preserving filter may be determined by using at least one of the below.

For example, a coefficient of an edge-preserving filter may be derived by using a bilateral function. A bilateral function may be represented as Formula 12 below.

$$\hat{I} ( x ) = \frac{1}{C} \cdot {\sum }_{y ∈ N ( x )} {e}^{\frac{- {‖ y - x ‖}^{2}}{2 {σ}_{d}^{2}}} \cdot {e}^{\frac{- {\vert I ( y ) - I ( x ) \vert}^{2}}{2 {σ}_{r}^{2}}} \cdot I ( y ) , \\ where C = {\sum }_{y ∈ N ( x )} {e}^{\frac{- {‖ y - x ‖}^{2}}{2 {σ}_{d}^{2}}} \cdot {e}^{\frac{- {\vert I ( y ) - I ( x ) \vert}^{2}}{2 {σ}_{r}^{2}}} \qquad [ Formula 12 ]$$

In Formula 12, σ_{d} may be a parameter (or spatial parameter) adjusting a weight considering a distance between two pixels x and y, and σᵣ may be a parameter (or range parameter) adjusting a weight considering a difference between pixels values I(x) and I(y) of receptive two pixels x and y. N may mean a number of pixels (y) within an area used for filtering a target pixel (x), and may be a positive integer.

For a spatial parameter σ_{d} or range parameter σᵣ or both, a fixed value may be used for all pixels. However, it is not limited thereto, a variable value determined on the basis of at least one of a block size, a block form, an intra/inter-prediction mode, a local feature of an image, a global feature of an image, and a coding parameter may be used.

σ_{d} or σᵣ or both may be determine as a value dependent on BitDepth. In an example, “σ_{d} or σᵣ=1<<(BitDepth−K)”, K may be a positive integer equal to or smaller than a bit depth or, may be 0.

Meanwhile, σ_{d} or σᵣ or both may be determined according to a block size. In an example, when a block size is N, N may be defined as at least one of a horizontal size, a vertical size, the sum of horizontal and vertical sizes, and the product of horizontal and vertical sizes of a block. Herein, when N becomes large, a large value of σ_{d} or σᵣ may be used, or when N becomes small, a large value of σ_{d} or σᵣ may be used.

Meanwhile, σ_{d} or σᵣ or both may be determined according to an intra-prediction mode or inter-prediction mode.

Meanwhile, when horizontal and vertical lengths of a current block are different, different values of σ_{d} or σᵣ may be respectively applied to horizontal directional filtering and vertical directional filtering.

Meanwhile, when a local feature of a pixel of an area for which filtering is performed or a global feature of an area for which filtering is performed or both is defined as a degree of homogeneity, when a degree of homogeneity becomes large, a large value of σ_{d} or σᵣ may be used. Alternatively, when a degree of homogeneity becomes small, a large value of σ_{d} or σᵣ may be used. Herein, an image feature may be determined in one of a picture unit, a block unit, a line unit, and a pixel unit.

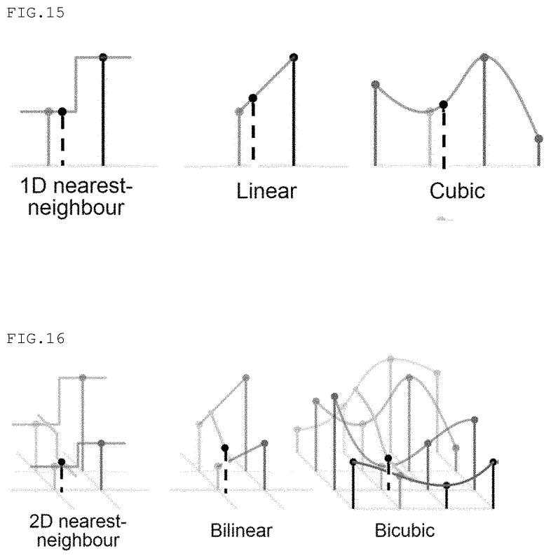

A 1D filter according to an embodiment of the present invention may be any one of a nearest-neighbor filter, a linear filter, and a cubic filter. A length of a 1D filter may be an arbitrary positive integer, and a coefficient of a 1D filter (or filter coefficients) may be derived as shown in FIG. 15.

In FIG. 15, a pixel represented in a dotted line may mean a target pixel for which filtering is performed, a pixel represented in a solid line may be a pixel within an area used for performing filtering for a target pixel, and a length of each of solid and dotted lines may mean a size of a filter coefficient.

A 2D filter according to an embodiment of the present invention may be any one of a 2D nearest-neighbor filter, a bilinear filter, and a bicubic filter. A length of a 2D filter may be an arbitrary positive integer, and a coefficient of a 2D filter (or filter coefficients) may be derived as shown in FIG. 16.

In FIG. 16, a pixel represented in a dotted line may mean a target pixel for which filtering is performed, a pixel represented in a solid line may be a pixel within an area used for performing filtering for a target pixel, and a length of each of solid and dotted lines may mean a size of a filter coefficient.

A target pixel for which order-statistic filtering according to an embodiment of the present invention, is performed and N pixels within an area used for performing filtering for a target pixel may be sorted in ascending or descending order, and a K-th value may be used as a filtered pixel value. Herein, N and K may be a positive integer satisfying K<=N.

Meanwhile, for a target pixel for which filtering is performed, at least one filter may be repeatedly or recursively applied. In addition, a filter coefficient or filter length or both may be set to a predefined valued in the encoder/decoder. In addition, a filter coefficient or filter length or both may be determined in the encoder and signaled to the decoder.

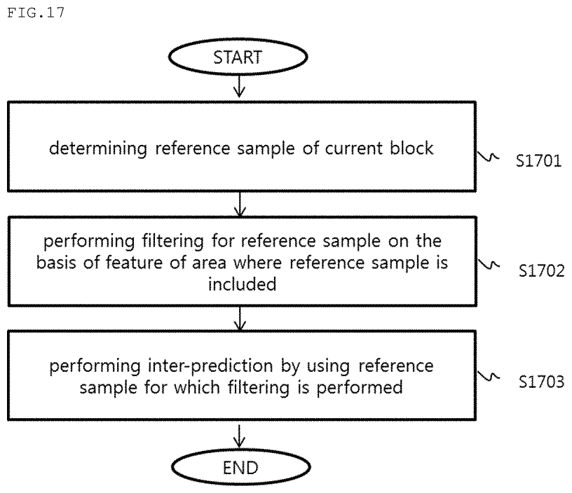

FIG. 17 is a view of a flowchart showing an image decoding method according to an embodiment of the present invention.

Referring to FIG. 17, in S1701, the decoder may determine a reference sample of a current block.

Herein, a reference sample of a current block may be at least one of at least one reconstructed sample line positioned at a left side of the current block, and at least one reconstructed sample line positioned at an upper side of the current block.

In addition, in S1702, the decoder may perform filtering for the reference sample on the basis of a feature of an area where the reference sample is included.

Herein, a feature of an area where the reference sample is included may be any one of a homogeneous area, an edge area, and a false edge area.

Meanwhile, performing filtering for the reference sample of S1702 includes: performs filtering by using a smoothing filter when the feature of the area where the reference sample is included in a homogeneous area; performs filtering by using an edge-preserving filter when the feature of the area where the reference sample is included is an edge area; and performs filtering by excluding a pixel determined to be noise when the feature of the area where the reference sample is included is a false edge area.

Herein, a feature of an area where a reference sample is included may be determined on the basis of a degree of homogeneity of the area.

Meanwhile, performing filtering for the reference sample of S1702 may include: determining a filter length on the basis of at least one of a size of the current block, a form of the current block, an intra-prediction mode of the current block, a division depth of the current block, and a pixel component of the current block; and filtering the reference sample on the basis of the determined filter length.

In addition, in S1703, the decoder may perform intra-prediction by using the reference sample for which filtering is performed.

Meanwhile, the decoder may generate a prediction block by using an interpolation filter when performing intra-prediction.

Herein, an interpolation filter type used in intra-prediction may be determined on the basis of whether or not to perform reference sample filtering or whether or not a condition for performing reference sample filtering according to an intra-prediction mode is satisfied.

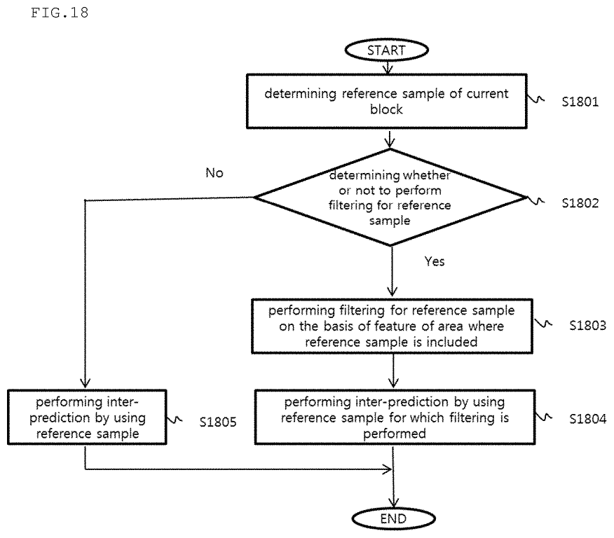

FIG. 18 is a view of a flowchart showing an image decoding method according to another embodiment of the present invention.

Referring to FIG. 18, in S1801, the decoder may determine a reference sample of a current block.

Subsequently, in S1802, the decoder may determine whether or not to perform reference sample filtering on the basis of at least one of a size of the current block, a form of the current block, an intra-prediction mode of the current block, a division depth of the current block, and a pixel component of the current block.

Subsequently, in S1802—Yes, when it is determined to perform reference sample filtering in S1802, in S1803, the decoder may perform reference sample filtering on the basis of a feature of an area where the reference sample is included.

Subsequently, in S1804, the decoder may perform intra-prediction by using the reference sample for which filtering is performed.

In S1802—No, when it is determined not to preform reference sample filtering in S1802, in S1805, the decoder may perform intra-prediction by using the reference sample determined in S1801.

An image decoding method described with FIGS. 17 and 18 may be identically performed in the encoder.

Meanwhile, a recording medium according to the present invention may include a bitstream generated by an image encoding method including: determining a reference sample of a current block; performing filtering for the reference sample on the basis of a feature of an area where the reference sample is included; and performing intra-prediction by using the reference sample for which filtering is performed.

The above embodiments may be performed in the same method in an encoder and a decoder.

It is possible to encode/decode an image using at least one or a combination of the above embodiments.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 or greater. For example, the above embodiments may be applied when a size of current block is 16×16 or greater. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied, additional identifier may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type to which the above embodiments of the present invention are applied may be defined, and the above embodiments may be applied depending on the corresponding slice type.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in encoding/decoding an image.

1. A method of decoding an image, the method comprising:
determining a reference sample of a current block;
performing filtering for the reference sample on the basis of a feature of an area where the reference sample is included; and
performing intra-prediction by using the reference sample for which filtering is performed.

2. The method of claim 1, wherein the feature of the area where the reference sample is included is any one of a homogeneous area, an edge area, and a false edge area.

3. The method of claim 2, wherein in the performing of filtering for the reference sample, filtering is performed by using a smoothing filter when the feature of the area where the reference sample is included is the homogeneous area.

4. The method of claim 2, wherein in the performing of filtering for the reference sample, filtering is performed by using an edge-preserving filter when the feature of the area where the reference sample is included is the edge area.

5. The method of claim 2, wherein in the performing of filtering for the reference sample, filtering is performed by excluding a sample determined to be noise when the feature of the area where the reference sample is included is the false edge area.

6. The method of claim 1, wherein the feature of the area where the reference sample is included is determined on the basis of a degree of homogeneity of the area.

7. The method of claim 1, further comprising: determining whether or not to perform filtering for the reference sample on the basis of at least one of a size of the current block, a form of the current block, an intra-prediction mode of the current block, a division depth of the current block, and a pixel component of the current block, wherein the performing of filtering for the reference sample is performed on the basis of the determined result.

8. The method of claim 1, wherein the performing of filtering for the reference sample includes:
determining a filter length on the basis of at least one of a size of the current block, a form of the current block, an intra-prediction mode of the current block, a division depth of the current block, and a pixel component of the current block; and
performing filtering for the reference sample on the basis of the determined filter length.

9. The method of claim 1, wherein the reference sample of the current block is at least one of at least one reconstructed sample line positioned at a left side of the current block and at least one reconstructed sample line positioned at an upper side of the current block.

10. A method of encoding an image, the method comprising:
determining a reference sample of a current block;
performing filtering for the reference sample on the basis of a feature of an area where the reference sample is included; and
performing intra-prediction by using the reference sample for which filtering is performed.

11. The method of claim 10, wherein the feature of the area where the reference sample is included is any one of a homogeneous area, an edge area, and a false edge area.

12. The method of claim 11, wherein in the performing of filtering for the reference sample, filtering is performed by using a smoothing filter when the feature of the area where the reference sample is included is the homogeneous area.

13. The method of claim 11, wherein in the performing of filtering for the reference sample, filtering is performed by using an edge-preserving filter when the feature of the area where the reference sample is included is the edge area.

14. The method of claim 11, wherein in the performing of filtering for the reference sample, filtering is performed by excluding a pixel determined to be noise when the feature of the area where the reference sample is included is the false edge area.

15. The method of claim 10, wherein the feature of the area where the reference sample is included is determined on the basis of a degree of homogeneity of the area.

16. The method of claim 10, further comprising:
determining whether or not to perform filtering for the reference sample on the basis of at least one of a size of the current block, a form of the current block, an intra-prediction mode of the current block, a division depth of the current block, and a pixel component of the current block, wherein the filtering for the reference sample is performed on the basis of the determined result.

17. The method of claim 10, wherein the performing of filtering for the reference sample includes:
determining a filter length on the basis of at least one of a size of the current block, a form of the current block, an intra-prediction mode of the current block, a division depth of the current block, and a pixel component of the current block; and
performing filtering for the reference sample on the basis of the determined filter length.

18. The method of claim 10, wherein the reference sample of the current block is at least one of at least one reconstructed sample line positioned at a left side of the current block, and at least one reconstructed sample line positioned at an upper side of the current block.

19. A recording medium storing a bitstream generated by an image encoding method, wherein the method includes:
determining a reference sample of a current block;
performing filtering for the reference sample on the basis of a feature of an area where the reference sample is included; and
performing intra-prediction by using the reference sample for which filtering is performed.
